(19) United States
(12) Patent Application Publication
(10) Pub. No.: US 2002/0091863 A1
(43) Pub. Date: Jul. 11, 2002

(54) Interoperable network communication architecture

(76) Inventor: Klaus H. Schug, Fort Collins, CO (US)

Correspondence Address: Roberts Abokhair & Mardula, L.L.C., Suite 1000, 11800 Sunrise Valley Drive, Reston, VA, 20191-5302, US

(21) Appl. No.: 10/045,692

(22) Filed: Oct. 19, 2001

Related U.S. Application Data
(63) Continuation-in-part of application No. 08/972,157, filed on Nov. 17, 1997, now abandoned.

(51) Int. Cl. G06F 9/44; G06F 13/00

(52) U.S. Cl. 709/250; 709/310

(57) ABSTRACT

A system and method for providing an interoperable network communication architecture for commercial off-the-shelf (COTS) computers, COTS network interface units (NUIs) and COTS programs uses three main programs integrated into one software library: a computer NIU driver, an IPP loop and an API. The NUI driver transfers network communicated data from the NIU to the OS physical memory with only one physical copying and uses the existing OS's functionality to map the data to the application address space. An integrated protocol processing loop performs all protocol processing on CPU word size increments, including checksum calculations, with minimal reads and writes. The IPP loop is integrated with the NIU driver and the API software functions. The API provides an application program interface very similar to the pre-existing, COTS OS APIs, making the interface transparent to pre-existing applications.

### RELATIONSHIP TO OTHER APPLICATIONS

This application is a continuation-in-part of U.S. application Ser. No. 08/972,157, filed Nov. 17, 1997, and incorporated herein by reference.

### FIELD OF THE INVENTION

This invention relates generally to computer network communications. More particularly, the present invention relates to a method to improve the internal computer throughput rate of network communicated data.

### BACKGROUND OF THE INVENTION

Network technology has advanced in the last few years from transmitting data at 10 million bits per second (Mbps) to one Gigabit per second (Gbps). At the same time, CPU technology inside computers has advanced from a clock rate of 10 Million cycles (Hertz) per second (MHz) to 1500 MHz. Despite the 500% to 1500% increase in network and CPU capabilities, the execution rate of programs that receive data over a network has only increased by a mere 200%, to a rate of approximately 4 Mbps. In addition, the internal computer delays associated with processing network communicated data have decreased only marginally despite orders of magnitude increase in network and CPU capabilities. Somewhere between the network interface (NI) and the CPU, the internal hardware and software architecture of computers is severely restricting data rates at the application program level and thereby negating network and CPU technology advances for network communication. As a result, very few network communication benefits have resulted from the faster network and CPU technologies.

Present research and prototype systems aimed at increasing internal computer throughput and reducing internal processing delay of network communicated data have all done so without increasing application level data throughput, or at the expense of interoperability, or both. For purposes of this specification, network communicated data includes all matter that is communicated over a network. Present research solutions and custom system implementations increase data throughput between the NI of the computer and the network. However, the data throughput of the application programs is either not increased, or is only increased by requiring new or highly modified versions of several or all of the following: application programs, computer OSs, internal machine architectures, communications protocols and NIs. In short, interoperability with all existing computer systems, programs and networks is lost.

A range of problems associated with network operations is still present. The present state of the art solutions for increasing the performance of internal computer architectures have one main shortcoming: they require a massive reinvestment by the computer user community in new machines, software programs and network technologies because of a lack of interoperability with existing computer systems and components.

All known prior art sacrifices interoperability in order to achieve higher internal computer system network communicated data performance (lower delays and higher data throughput). Some systems use proprietary protocols, specialized NIs and custom OSs in order to achieve higher performance.

Existing prototype and research NIs can be grouped into four broad categories: outboard processing, direct user space data transfer, application specific handlers, and minimum NI functionality.

Outboard processing approaches to NI implementation attempt to perform communications processing on Network Interface Unit (NIU) hardware (e.g., network interface cards or specialized semiconductor circuits such as digital signal processors—DSPs and associated circuitry), before transferring control and data to the OS or to the networking application. Moving protocol processing to the NIU can reduce communication overhead on the host and improve overall communication performance. The amount of processing moved to the NIU ranges from the calculation of the protocol checksums, to the performance of connection/message multiplexing/demultiplexing and up to the execution of the complete protocol suite. Checksum calculation in the NIU hardware can result in some performance gains. The transport protocol (i.e., Transport Control Protocol—TCP or User Datagram Protocol—UDP) checksum can by calculated during the data transfer to the NIU by having the data link layer apply the checksum routine as it copies the data and inserts the resulting checksum value in a specific location in the transport header.

If a layered structuring of the protocol code, separation of Data Link and Transport Layer, is to be maintained, then both the checksum routine and the checksum location in the header must be supplied by the transport layer through a well-defined interface. In Steenkiste et al. [P. A. Steenkiste, B. D. Zill, H. T. Kung, S. J. Schlick, J. Hughes, B. Kowalski, and J. Mullaney, “A Host Interface Architecture For High-Speed Networks”, Proceedings of the 4th IFIP Conference on High Performance Networks, IFIP, Liege, Belgium, pp. A3 1-16, December 1992.] a similar technique is used where the checksum is calculated in hardware during the direct memory access (DMA) transfer. Kay et al. [J. Kay and J. Pasquale, “Measurement, Analysis, And Improvement of UDP/IP Throughput For The DECstation 5000”, Proceedings of the USENIX Winter Technical Conference, pp. 249-258, San Diego, Calif., January 1993 and J. Kay and J. Pasquale, “The Importance Of Non-Data Touching Processing Overheads In TCP/IP”, Proceedings of the ACM Communications Architectures and Protocols Conference (SIGCOMM), pp. 259-269, San Francisco, Calif., September 1993.] show that although checksum calculation is the highest communications overhead cost for messages less than approximately 676 bytes, it is a small percentage of the overhead for larger messages. Data throughput improvements for small messages with checksumming performed on the NIU can be significant. In general, however, there will not be a significant impact on the overall application program data throughput performance.

Checksum calculation on the NIU requires an interface that might require protocol modifications, bringing on all the drawbacks of non-interoperability.

Another consideration is that in practice, a single machine will run applications that use different programming interfaces and possibly different protocols, so checksumming of commercial off-the-shelf (COTS) standard network protocols such as TCP and UDP can not always be used and may render the NIU unusable for other protocols.

Moving network message multiplexing and demultiplexing to the NIU is a more aggressive form of outboard processing NIU implementation. As pointed out in Feldmeier [D. C. Feldmeier, “Multiplexing Issues In Communication System Design,” in Proc. ACM SIGCOMM 90, Philadelphia, Pa., pp. 209-219, September 1990.], multiplexing is a key issue to network performance. NIUs may support packet demultiplexing prior to data transfer to main memory, allowing filtering and selective placement of data units in memory. In the simplest case, the adapter allows the computer to peek at a network packet's header. The CPU makes the demultiplexing decision and initiates the data transfer to the appropriate location in main memory, using DMA or programmed input/output (I/O). More elaborate, non-COTS NIUs can be programmed by the CPU to automatically recognize network packets by matching their headers, and place them into appropriate memory locations using DMA. The use of a message multiplexing/demultiplexing filtering method such as the Dynamic Packet Filters in Engler [D. R. Engler, and M. F. Kaashoek, “DPF: Fast, Flexible Message Demultiplexing Using Dynamic Code Generation”, Proceedings of ACM SIGCOMM'96 Conference on Applications, Technologies, Architectures and Protocols for Computer Communication, 1996.], can reduce message overhead by 50 microseconds (μs) per message up to and including the transport layer protocols.

For other than small messages, outboard multiplexing and demultiplexing is a very small part of the network communications overhead. A severe drawback to this technique is that all new application program interfaces (APIs) would be required along with new NIUs for existing machines, new OS software drivers and main memory (DMA or programmed I/O) transfer interfaces. Interoperability with all existing systems would be compromised at a marginal performance improvement.

Protocol processing can also be performed in the NIU, outboard from the computer internals and the CPU as described in Cooper et al. [E. Cooper, P. Steenkiste, R. Sansom, and B. Zill, “Protocol Implementation On The Nectar Communication Processor”, Proceedings of the ACM SIGCOMM '90 Symposium on Communications Architectures and Protocols, ACM, Philadelphia, Pa., pp. 135-143, September 1990.] and Kanakia et al. [H. Kanakia and D. R. Cheriton, “The VMP Network Adapter Board (NAB): High-Performance Network Communication For Multiprocessors”, In Proceedings SIGCOMM '88 Symposium on Communications Architectures and Protocols, Stanford, Calif., pp. 175-187, 1988.]. The extreme case of an outboard NIU is exemplified by Cooper et al.'s Nectar co-processor NIU approach. The Nectar Communications Accelerator Board includes a microcontroller with a complete, custom, non-COTS multithreaded operating system. Less protocol processing is performed by two Asynchronous Transfer Mode (ATM) NIUs developed at Bellcore and the University of Pennsylvania. Bellcore's ATM NIU implementation, described in Davie [B. S. Davie, “A Host-Network Interface Architecture For ATM”, in Proceedings, SIGCOMM 1991, Zurich, SWITZERLAND, pp. 307-315, September 1991.], attaches to the TURBO Channel bus of the DECstation 5000 workstation. The ATM NIU operates on cells, and communicates protocol data units (PDUs) to and from the host. Like Nectar, this NIU relies on programmable processors, two Intel 80960 Reduced Instruction Set Computer (RISC) micro-controllers, to perform protocol processing and flow control. In this case, the programmability is targeted primarily at exploring various segmentation-and-reassembly (SAR) algorithms.

Outboard protocol processing, the most aggressive option, has a number of disadvantages. First, the NIU becomes more complex and expensive, especially if multiple protocols have to be supported. One of the reasons is that the engine performing protocol processing should be fast, preferably as fast as the host CPU. Second, interactions between the OS, applications and the NIU can become complicated. For example, flow control and a revamped virtual/physical memory management/protection mechanisms are needed between the OS, applications and the NIU, if the host and adapter do not share memory. There are no known control and memory management mechanisms that provide interoperability with existing COTS OSs (e.g., UNIX, LINUX, Windows, NT, MacOS) and NIUs. Off-board processors can migrate many processing and data movement tasks away from the host CPU and improve performance, however the cost is very high in that all interoperability with existing legacy systems is lost.

Direct user memory space data transfer, performing direct network data transfer from the NIU to the user, is another approach to avoiding the CPU/memory bottleneck. Direct user space data transfer attempts to remove, as much as possible, both the CPU and main memory from the data path. The data path may be set up and controlled by software, but the data itself is transferred from the NIU to the user application program without, or with minimal, CPU involvement. OS-Bypass for NIU to user data transfers has been studied and evaluated using a number of experimental implementations: Active Messages [see, e.g., T. von Eicken, V. Avula, A. Basu and V. Buch, “Low-Latency Communication Over ATM Networks Using Active Messages”, IEEE Micro, Vol. 15, No. 1, pp. 46-53, February 1995; D. Culler, K. Keeton, L. T. Liu, A. Mainwaring, R. Martin, S. Rodrigues, K. Wright and C. Yoshikawa, “The Generic Active Message Interface Specification”, Department of Electrical Engineering and Computer Science, University of California at Berkeley, February 1995; L. T. Liu, A. Mainwaring and C. Yoshikawa, “White Paper On Building TCP/IP Active Messages”, Department of Electrical Engineering and Computer Science, University of California at Berkeley, November 1994; R. P. Martin, “HPAM: An Active Message Layer For A Network Of HP Workstations”, CSD-96-891, Department of Electrical Engineering and Computer Science, University of California at Berkeley, December 1995; L. T. Liu and D. E. Culler, “Measurement Of Active Message Performance On The CM-5”, CSD-94-807, Department of Electrical Engineering and Computer Science, University of California at Berkeley, May 1994.; T. von Eicken, D. Culler, S. C. Goldstein and K. Schauser, “Active Messages: A Mechanism For Integrated Communication And Computation”, in Proc. of 19th ISCA, pp. 256-266, May 1992.]; an active messages derivative—User-Level Network Interface (U-Net) [see: T. von Eicken, A. Basu, V. Buch, and W. Vogels, “U-Net: A User-Level Network Interface For Parallel And Distributed Computing”, Proc. of the 15th ACM Symposium on Operating Systems Principles, Copper Mountain, Colo., Dec. 3-6, 1995; M. Welsh, A. Basu, and T. von Eicken, “ATM And FastEthernet Network Interfaces for User-level Communication”, Proceedings of the Third International Symposium on High Performance Computer Architecture, Feb. 1-5, 1997; M. Welsh, A. Basu, and T. von Eicken, “Incorporating Memory Management Into User-Level Network Interfaces”, U-Net paper: unetmm.ps, Department of Computer Science, Cornell University, Ithaca, N.Y., November 1996; K. K. Keeton,. E. Anderson, and D. A. Patterson, “LogP Quantified: The Case For Low-Overhead Local Area Networks”, Hot Interconnects III: A Symposium on High Performance Interconnects, Stanford University, Stanford, Calif., Aug. 10-12, 1995; Osborne U.S. Pat. No. 5,790,804]; Application Specific Handlers (ASH) [D. A. Wallach, D. R. Engler, and M. F. Kaashoek, “ASHs: Application-Specific Handlers For High-Performance Messaging”, Proceedings of ACM SIGCOMM'96 Conference on Applications, Technologies, Architectures and Protocols for Computer Communication, August 1996]; Fast Messages [S. Pakin, M. Lauria, and A. Chien, “High Performance Messaging On Workstations: Illinois Fast Messages (FM) for Myrinet”, In Proc. of Supercomputing '95, San Diego, Calif., 1995]; Hewlett-Packard (HP) Hamlyn [J. Wilkes, “An Interface For Sender-Based Communication”, Tech. Rep. HPL-OSR-92-13, Hewlett-Packard Research Laboratory, November 1992]; Shrimp [M. Blumrich, C. Dubnicki, E. W. Felten and K. Li, “Virtual-Memory-Mapped Network Interfaces”, IEEE Micro, Vol. 15, No. 1, pp. 21-28, February 1995]; and ParaStation [T. M. Warschko, W. F. Tichy, and C. H. Herter, “Efficient Parallel Computing On Workstation Clusters”, Technical Report 21/95, University of Karlsruhe, Dept. of Informatics, Karlsruhe, Germany, 1995].

In all of these methods, data is transferred directly between application memory buffers and the network with little or no OS intervention. Active Messages and the active message derivatives (e.g., U-Net and Osborne Patent) require non-COTS, non-interoperable host or network hardware and software components: an intelligent NIU with programming and processing capabilities, a specialized OS, a specialized protocol, modification to existing application programs, apriori knowledge of recipient addresses, or any combination of these. In “Computer Network Interface and Network Protocol with Direct Deposit Messaging”, U.S. Pat. No. 5,790,804, August 1998, non-COTS, non-interoperable hardware and software components (NIU, OS, protocol, application program modifications/custom implementations and apriori knowledge of recipient addresses) are required. These requirements render the present direct to user memory data transfer methods, including the Osborne U.S. Pat. No. 5,790,804, non-interoperable and non-usable with existing systems.

For the present direct to user memory data transfer methods, a programmable NIU with specialized registers is required to directly execute network communicated data messages, place the messages directly into the physical application memory and avoid the use of the OS for message handling. A specialized OS (e.g., Mach 3) is required to allow a non-OS component to directly place network communicated data into memory and to manage the resulting virtual memory and physical memory allocations, protections and cache memory mappings/consistency.

A unique communications protocol is used with a combination of sender-based and receiver-based control and data information. Such a protocol requires apriori knowledge of data syntax and format, and the network communicated data message recipient's machine/applications internal memory addresses. Such knowledge is impossible to obtain without some kind of “out of band” a priori communication initiation knowledge transmission, a situation impossible to achieve in a public network.

Applications must be modified to interface to the intelligent NIU, to provide some protocol functionality and must be provided apriori knowledge of data syntax, format and addresses. Keeton et al. [K. K. Keeton, E. Anderson, and D. A. Patterson, “LogP Quantified: The Case For Low-Overhead Local Area Networks”, Hot Interconnects III: A Symposium on High Performance Interconnects, Stanford University, Stanford, Calif., Aug. 10-12, 1995] illustrates the performance improvement of direct data transfer methods using custom NIU hardware and corresponding custom OS extensions or COTS by-pass mechanisms. The HP Medusa FDDI NIUs and OS extensions direct to user space data transfer shows that complete host system customization has improved performance significantly, removing the data transfer overhead as the network data throughput limitation.

By bypassing the COTS OS, and hence the OS memory management and protocol processing functions, all of the direct memory transfer methods of performance improvement become non-interoperable, unable to function on pre-existing systems without substantial investment in hardware and software modifications. Even with extensive modifications, interoperability cannot be achieved with systems beyond the control of the implementing agency, e.g., host machines on other organizations networks that do not wish to make the same modifications.

Using the memory shared between the NIU, OS and user to transfer network data is another direct network data transfer approach to improving network communicated data throughput inside host computers. This technique is also known as user level streaming. Virtual memory is statically shared among two (OS and user or NIU and user) or more (NIU, OS and user 1, user 2, user n) domains. For example, the DEC Firefly remote procedure call (RPC) facility uses a pool of buffers that is globally and permanently shared among all domains [see M. D. Schroeder and M. Burrows, “Performance Of Firefly RPC”, ACM Transactions on Computer Systems, Vol. 8, No. 1, pp. 1-17, February 1990]. Since all domains have read and write access permissions to the entire pool, protection and security are compromised. Data is copied between the shared buffer pool and an application's private memory. As another example, lightweight remote procedure call (LRPC) [see B. Bershad, T. Anderson, E. Lazowska, and H. Levy, “Lightweight Remote Procedure Call”, ACM Transactions on Computer Systems, Vol. 8, No. 1, pp. 37-55, February 1990] uses argument stacks that are shared between communicating protection domains. Both techniques reduce the number of copies required, rather than eliminating copying.

Using statically shared memory to eliminate all copying poses problems. Globally shared memory compromises security, pairwise shared memory requires copying when data is either not immediately consumed or is forwarded to a third domain, and group-wise shared memory requires that the data path of a buffer is always known at the time of allocation (e.g., at network data arrival time). All forms of shared memory may compromise protection between the sharing domains.

The Illinois Fast Messages [see S. Pakin, M. Lauria, and A. Chien, “High Performance Messaging On Workstations: Illinois Fast Messages (FM) for Myrinet”, In Proc. of Supercomputing '95, San Diego, Calif., 1995] achieve high performance on a Myrinet network using communication primitives similar to Active Messages. Systems that attempt to avoid data copying by transferring data directly between OS (e.g., UNIX) application buffers and the NIU, such as described above and in Dalton et al. [C. Dalton, G. Watson, D. Banks, C. Calamvokis, A. Edwards, and J. Lumley, “Afterburner”, IEEE Network, Vol. 7, No. 4, pp. 36-43, July 1993], work only when data is accessed in only a single application domain, where network data is always for one application only. The network interface is accessed directly from user-space but does not provide support for simultaneous use by multiple applications. A substantial amount of memory may be required in the network adapter when interfacing to high-bandwidth, high-latency networks. Moreover, this memory is a limited resource dedicated to network buffering.

The HP Hamlyn network architecture [see: J. Wilkes, “An Interface For Sender-Based Communication”, Tech. Rep. HPL-OSR-92-13, Hewlett-Packard Research Laboratory, November 1992] also implements a user-level communication model similar to Active Messages, but uses a custom network interface where message sends and receives are implemented in hardware. Shrimp [M. Blumrich, C. Dubnicki, E. W. Felten and K. Li, “Virtual-Memory-Mapped Network Interfaces”, IEEE Micro, Vol. 15, No. 1, pp. 21-28, February 1995] allows processes to connect virtual memory pages on two nodes through the use of custom network interfaces. Memory accesses to such pages on one machines need to be automatically mirrored on the other machine via custom software.

The ParaStation system [T. M. Warschko, W. F. Tichy, and C. H. Herter, “Efficient Parallel Computing On Workstation Clusters”, Technical Report 21/95, University of Karlsruhe, Dept. of Informatics, Karlsruhe, Germany, 1995] requires specialized hardware and user-level unprotected access to the network interface. NIUs and the internal machine memory bus must support peer-to-peer transfers, and in hardware-based methods, the NIU must be able to perform demultiplexing and any necessary data format conversions. NIUs that support a fixed set of NIU to user network data transfer capabilities offer little room for innovation in high-bandwidth applications.

An alternative is for the NIU adapter to provide components that can be programmed by applications. This can take the form of special-purpose processors, or programmable circuitry. Unfortunately, this approach has problems of its own. First, it is difficult for applications to use programmable device adapters in a portable way. Second, at any given point in time, the technology used in I/O adapter hardware tends to lag behind that of the main computer system, due to economics. Consequently, applications that rely on out-board processing may not be able to exploit performance gains resulting from an upgrade of the host computer system. User program memory space is allocated to a different region of memory than OS memory space to provide system and application code protection from one another. In many cases, removing the kernel from the communication data path leaves the NIU or additional software as the only place where memory execution domain protection can be implemented. Flow control may also have to be implemented in the NIU, otherwise an application might overload the network.

The direct user space data transfer based techniques to improve internal host network communicated data performance make substantial improvements at both the lower levels and at the application program level. Performance can be significantly enhanced with direct memory transfer methods, but not without a tremendous cost of a lack of interoperability with pre-existing systems. Active Messages, active message derivatives (e.g., U-Net and Osborne Patent) and all other existing direct user space data transfer performance enhancements require non-COTS, non-interoperable host or network hardware and software components: an intelligent NIU with programming and processing capabilities, a specialized OS, a specialized protocol, modification to existing application programs, apriori knowledge of recipient addresses or any combination of these.

Another method of improving NI performance is to use application-specific handlers (ASHs) [see: D. A. Wallach, D. R. Engler, and M. F. Kaashoek, “ASHs: Application-Specific Handlers For High-Performance Messaging”, Proceedings of ACM SIGCOMM'96 Conference on Applications, Technologies, Architectures and Protocols for Computer Communication, August 1996] to perform data transfer. ASHs are routines written by application programmers that are downloaded into the kernel and invoked after a message is demultiplexed (after it has been determined for whom the message is destined). From the kernel's point of view, an ASH is simply code, invoked upon message arrival, that either consumes the message it is given or returns it to the kernel to be handled normally. ASHs are made “safe” to execute in the OS kernel by controlling their operations and bounding their runtime. This ability gives applications a simple interface, a system call, with which to incorporate domain-specific knowledge into message-handling routines.

Operationally, ASH construction and integration has three steps. First, client routines are written using a combination of specialized “library” functions and any high-level language that adheres to C-style calling conventions and runtime requirements. Second, these routines are downloaded into the operating system in the form of machine code, and given to the ASH system. The ASH system post-processes this object code, ensuring that the user handler is safe through a combination of static and runtime checks, then hands an identifier back to the user. Third, the ASH is associated with a user-specified demultiplexor.

When the demultiplexor accepts a packet for an application, the ASH will be invoked. ASHs provide three main functions 1) direct, dynamic message vectoring—An ASH dynamically controls where messages are copied in memory, and can therefore eliminate intermediate copies, 2) control initiation—ASHs can perform checksumming or complete protocol computation, 3) message initiation—ASHs can send messages directly from the application memory. The ASH system has been implemented in an experimental OS, Aegis [see: D. R. Engler, M. F. Kaashoek, and J. W. O'Toole Jr., “Exokernel: An Operating System Architecture For Application-Specific Resource Management”, In Proceedings of the Fifteenth ACM Symposium Operating Systems Principles, pp. 251-266, Copper Mountain Resort, Colo., December 1995], for DECstation machines, yielding some performance specifics. The performance of ASHs is in many cases better than the performance of other high-performance NI implementations discussed earlier, which also perform direct NIU to user data transfers.

Direct comparisons with other complete high-performance systems such as Osiris [P. Druschel, L. L. Peterson, and B. S. Davie, “Experiences With A High-Speed Network Adaptor: A Software Perspective”, in ACM Communication Architectures, Protocols, and Applications (SIGCOMM '94), pp. 2-13, London, UK, August 1994], Afterburner [A. Edwards, G. Watson, J. Lumley, D. Banks, C. Clamvokis, and C. Dalton, “User-Space Protocols Deliver High Performance To Applications On A Low-Cost Gb/s LAN”, in ACM Communication Architectures, Protocols, and Applications (SIGCOMM '94), pp. 14-24, London, UK, August 1994] and the Osborne patent are difficult since they run on different networks and have special purpose network cards. ASHs are very similar to Active Messages and U-Net, but typically include protocol processing as part of the handler and are loaded into the OS.

The cost of ASHs is in the additional programming required for each application, network interface and OS combination. It has not been possible to incorporate ASHs into pre-existing systems without major impact to the existing systems, networks, applications, NIUs and OSs. ASHs do not interoperate with existing systems.

Minimum functionality in the NIU is another method to improve internal host network communicated data performance. Fore Systems, Inc. [E. Cooper, O. Menzilcioglu, R. Sansom, and F. Bitz, “Host Interface Design For ATM LANs,” in Proceedings, 16th Conference on Local Computer Networks, Minneapolis, Minn., pp. 247-258, Oct. 14-17, 1991], and Cambridge University/Olivetti Research [D. J. Greaves, D. McAuley, and L. J. French, “Protocol And Interface For ATM LANs,” in Proceedings, 5th IEEE Workshop on Metropolitan Area Networks, Taormina, Italy, May 1992], have each explored an approach which puts minimal functionality in the NIU. This approach assigns almost all tasks to the host computer CPU including ATM adaptation layer processing, e.g., computing checksums, checking segment numbers, etc. Minimalist approaches can take advantage of CPU technology improvement, which might outstrip that of NIU components.

However, such an approach has two drawbacks. First, RISC CPUs are optimized for data processing, not data movement, and hence the host computer must devote significant resources to manage high-rate data movement. Second, the OS overhead of message buffer management of such an approach can be substantial without hardware assistance for data coalescing and data transfer management. By using the CPU and OS to perform all the NI functions, none of the current performance bottlenecks are addressed and no performance improvements are made. This does not seem to be a viable approach for reducing NI overhead.

None of the existing methods of improving internal host network communicated data performance are interoperable with all pre-existing and foreseeable future application program, host computer, OSs, NIs, NIUs, LANs and WANs) and international, national and DeFacto standard communication protocols. Performance can be significantly enhanced with direct memory transfer methods, but not without a tremendous cost of a lack of interoperability with pre-existing systems. Active Messages, active message derivatives (e.g., U-Net and Osborne Patent) and all other existing direct user space data transfer performance enhancements require non-COTS, non-interoperable host or network hardware and software components: an intelligent NIU with programming and processing capabilities, a specialized OS, a specialized protocol, modification to existing application programs, apriori knowledge of recipient addresses or any combination of these. As a result, none of these solutions have seen, nor are they likely to see, commercial implementation.

A need therefore exists for higher network communicated data throughput inside computers to allow high data rate and low processing delay network communication while maintaining interoperability with existing application programs, computers, OSs, NIs, networks and communication protocols. The Interoperable Network Communications Architecture (INCA) of the present invention eliminates the non-interoperability features and requirements of existing direct user space data transfer performance designs and implementations.

### SUMMARY OF THE INVENTION

To eliminate the interoperability limitations with the prior art, this invention, henceforth referred to as INCA—Interoperable Network Communications Architecture, provides a software library of programs that can be added to any pre-existing host computer with complete interoperability of all existing components and without requiring any additional or replacement components. INCA improves the internal throughput of network communicated data of workstation and personal computer (PC) class computers at the user application program level by greatly reducing the number of memory accesses. INCA speeds up internal network communicated data handling to such a degree that data can be transferred to and from the application programs, via the network interface, at speeds approaching that of high speed network communicated data transmission rates.

The CPU utilization is increased by reducing the amount of time spent waiting on memory accesses from cache misses, and reads and writes of the network communicated data and protocol processing. The invention greatly reduces the number of cache memory misses by forcing protocol processing to conform to the cache operating principle of locality of reference. The entire cache memory pipeline (random access memory—RAM, level 1, level 2, level n caches) needs to be emptied and refilled hundreds to thousands of times less often, eliminating CPU idle time waiting for correct cache memory contents. In addition, the invention greatly reduces the number of times network communicated data must be transferred across the internal computer memory bus. The continually increasing CPU performance can therefore be utilized by keeping the CPU processing data in order to continually increase the throughput and decrease the delays of network communicated data processing. The processing times of pre-existing and future international, national and de-facto standard communication protocols is greatly reduced.

The time required to service network messages not addressed to the host computer or applications on the host computer is reduced because of increased protocol processing such as address matching and checksumming. The performance of non-networking applications on networked computers is therefore increased by processing network management messages and messages not addressed to the machine at least four times faster than presently processed, allowing more CPU time for applications executing at the time of message arrival.

The set of software routines, when added to a host computer system with a computer NIU, use the pre-existing CPU, NIU, other system hardware and the OS, to send, receive or send and receive network communicated data. The pre-existing network communication protocols are included in the INCA software library so that the impact on the pre-existing system hardware and software components, including the application programs, is to see a tremendous improvement in the throughput of network communicated data without adding or altering existing component functionality. Complete interoperability is achieved in that in the matter of minutes required to add the INCA software to an existing system, no components are removed, no programming is required and no alteration of existing interfaces or functionality is performed.

INCA's increased performance is gained with all the benefits of interoperability: no custom, unique, difficult to maintain , single source hardware or software components are required, no reliance on INCA's provider is required in that all of the INCA software can be maintained by the host computer's responsible organization, the INCA software is portable from machine to machine, and INCA's modularity will quickly accommodate changes in network interfaces and protocols. Interoperability even with those machines not utilizing INCA is maintained. All other existing methods, such as Osborne's Patent, require all communicating systems to have the same custom, unique hardware and or software in order to communicate over a network.

Upon network communicated data arrival at the host computer, NIUs typically notify the processor that a message has arrived with an address matching that of an entity (e.g., application program) address within the host computer. If INCA is made a part of the host computer OS functionality, then the host OS receives the NIU message interrupt as in current art systems, with the INCA software additions to the OS handling message arrival and processing functions. If the INCA software library is linked to or made part of the application program, then the application program's INCA software intercepts the message notification, minimizing OS message arrival and processing function utilization.

In either case, whether part of the OS or used via application programs, the INCA software performs most message arrival and processing functions. Upon message arrival, the INCA software transfers the message from the NIU to OS memory message buffers in the host computer memory. Multiplexing and demultiplexing of messages is accomplished via separate OS message buffers set up for different applications and for separate communications with the same application. The OS message buffers are mapped to the application's memory address space using the existing OS memory mapping services in order to avoid an additional physical copying of the message data from OS memory to application memory. Using the existing OS memory mapping services eliminates any modifications to the existing OS, which would be required to handle virtual to memory address mapping problems caused by a non-OS entity controlling and manipulating memory.

At this point, INCA's integrated protocol processing (IPP) loop performs communication protocol processing. Standard, COTS protocols such as the Internet Protocol (IP), TCP, UDP and XTP are all executed inside a single processing loop by INCA, forcing adherence of memory references to the principle of locality of reference. References to memory for data and instructions for processing network messages now are in memory locations very near the previously needed data and instructions. The RAM-cache level n pipeline is filled with the correct data and instructions, greatly reducing cache misses and the associated memory pipeline refill times. The number of memory reads and writes are greatly reduced, speeding up message processing. A CPU word size segment of the message is read into the processor and all protocols and their processing, including checksumming and individual protocol functions, are performed on the data segment before the data is written back to the application. For example, IP checksumming might be performed first, followed by other IP functions, then TCP checksumming, more TCP functions and finally data transformation functions (e.g., XTP protocol) would be performed, all without writing the data segment out of the CPU until the last data touching or data manipulation function is completed. Then the next message data segment would be read into the CPU and the protocol processing cycle would begin again. Once out of the IPP loop, the data is available to the application to use.

An API completes the INCA software library and allows the application access to the fully processed data. In the case of INCA software interfaced or added to the OS, the existing system and OS API serves as the method of initiating INCA functionality and controlling the message processing for either send or receive by an application. In the case of INCA interfaced or added to an application program's functionality, the INCA API serves as the application's ability to interface to the existing OS and control the host hardware (e.g., CPU, memory and NIU) and the OS message buffers to perform network communicated data processing using the INCA software.

FIG. 1 illustrates the typical existing network communication system inside a computer. When a message 190 is received by the NIU 140, the NIU sends an interrupt signal 142 to the OS 120. The network communicated data is then copied from the NIU 140 into the OS message buffers 161 which are located in the OS memory address space 160. Once the network communicated data is available in the OS message buffers 160, the OS 120 typically copies the network communicated data into the Internet Protocol (IP) address space 171. Once IP processing is completed, the network communicated data is copied to the UDP/TCP address space 175. Once the UDP processing is completed, if any additional protocols are used external to the application program, the network communicated data is copied to the Other Protocol address space 176 where the network communicated data is processed further. The network communicated data is then copied to the API address space 172. Finally, the application reads the network communicated data, which requires another copy of the network communicated data into the application memory address space 170. As illustrated in FIG. 1, copying of the network communicated data occurs numerous times in the normal course of present operations.

FIG. 2 and FIG. 18 illustrate the INCA network communication system. Contrasting INCA to the typical network communication system in FIG. 1, it is evident INCA eliminates several data copying steps and as a result, INCA performs in a more efficient manner for increasing a network's data throughput rate. In addition, INCA implements several other efficiency improving steps that will be discussed in the following detailed description section.

As shown in FIG. 2, the present invention comprises three main software components: an INCA NIU driver 200, an IPP execution loop 201 and an API 202. These components reside inside a computer together with the current computer software components such as application programs 210, OS 220, communication protocols 230, and the current computer hardware components such as the NIU 240, system memory bus 250 and 280, memory 260, 270 and one or more CPUs, disks, etc.

The INCA software is a communications architecture that provides tremendous performance improvement for network communicated data processing inside a host computer. INCA's software library with three software components can be added and interfaced to either the existing OS or to existing applications on the host computer in a matter of minutes, while maintaining interoperability with all pre-existing components. Current system components and their pre-existing functionality perform as before installation of INCA, providing performance improvement with all the benefits of interoperability—a minimum of system impact and cost. The present invention, INCA, provides the following advantages over the existing art.

1. Network communicated data throughput at the application level (not just NIU to network level) is greatly increased for small messages (less than or equal 200 bytes) and for large messages.

2. Communication protocol processing for all levels and types of existing and future international, national and de-facto protocols is sped up.

3. The amount of times network communicated data is sent across the internal computer memory busses greatly reduced.

4. The processing of network messages and protocols is made to match the operation of the memory subsystem (RAM-cache level n) in that memory references to required data and instructions are forced to adhere to the memory pipeline operating principle of locality of reference.

5. The performance of non-networking applications on networked computers is increased by processing network management messages and messages not addressed to the machine at least four times faster than presently processed.

6. The full utilization of high-speed network and CPU technologies is made possible by enabling applications to process data at high speed network rates.

7. All advantages and performance improvements are made with complete interoperability and without modification of the existing system and network hardware and software components and their operations.

### BRIEF DESCRIPTION OF THE DRAWINGS

FIG. 1 shows an overview of a typical prior art, existing network communication system.

FIG. 2 shows an overview of the INCA network communication system with one possible embodiment of INCA integrated into the application program.

FIG. 3 shows an overview of the network data/mapping addressing mechanism.

FIG. 4a shows examples of the typical non-INCA, non-IPP for-loops used for protocol processing.

FIG. 4b shows an example of a single, integrated INCA IPP for-loop used for protocol processing.

FIG. 5 shows the INCA IPP stages of protocol execution.

FIG. 6 shows the INCA IPP method of integrating various protocols into a single execution loop.

FIG. 7 shows the INCA API.

FIG. 8 shows INCA's performance improvement on workstation (WS) class computers.

FIG. 9 shows INCA's small message size performance improvement on PC class computers.

FIG. 10 shows INCA's performance improvement with all standard message sizes on PC class computers.

FIG. 11 shows INCA's management and control flow.

FIG. 12 shows the INCA NIU driver component entry points data structure.

FIG. 13 illustrates an INCA IPP sample implementation with byte swapping and protocol checksumming functions integrated into a processing loop.

FIG. 14 depicts the INCA Integrated Protocol Processing Loop for the TCP Protocol.

FIG. 15 illustrates an INCA Integrated Protocol Processing Loop sample implementation with checksum calculation and protocol control function processing integrated into a processing loop.

FIG. 16 illustrates an INCA Integrated Protocol Processing Loop sample implementation with TCP and IP protocol checksum calculation and protocol header creation integrated into a processing loop.

FIG. 17 depicts the INCA Integrated Protocol Processing Loop for the UDP Protocol.

FIG. 18 shows an overview of the INCA network communication system with another possible embodiment of INCA integrated into the OS.

### DETAILED DESCRIPTION OF THE INVENTION

INCA is composed of three main programs integrated into one software library: a computer NIU driver, an IPP loop and an API. The INCA library employs both threads and lightweight processes as the means of executing and implementing each of the three components. A thread is defined as a sequence of instructions executed within the context of a process. A lightweight process is defined as a thread that runs in the kernel and executes kernel code and system calls. A lightweight process is an OS kernel resource and is allocated from a pool of lightweight processes running the OS kernel. The INCA software library uses lightweight processes to run the threads of the three components making up the INCA library. An INCA thread is allocated a lightweight process at the time of its scheduling by the thread library from a pool of kernel lightweight processes.

INCA also makes use of bounded threads where a thread is permanently assigned an lightweight process. An INCA thread has the process context and runs within the process address space using the process virtual memory for storing the thread context. The switching between the user threads is very inexpensive. In the case of a multiprocessor host computer, the OS and the threads library takes care of scheduling each thread in a different processor, thus allowing for parallel execution of the INCA software library. The INCA NIU driver comprises software that controls the NIU hardware and transfers the network communicated messages from the network to the host computer's memory.

The IPP loop software performs communication protocol processing functions such as error handling, addressing, reassembly and data extraction from the network message. The API software passes the network communicated data sent via the network to the application program that needs the network communicated data. The same process works in reverse for transmitting network communicated data from the application over the network to a remote computer. The existing computer components, e.g., the NIU, CPU, main memory and DMA hardware, and the OS and application program software, are used as is, with control or execution of these resources being altered by the INCA software functions. Each of the three components of INCA will now be discussed in detail.

INCA NIU Driver

The INCA NIU driver component 200 is a software set of programming language functions, a software module, adding to the existing OS kernel (e.g., UNIX, LINUX, Windows, etc.) NIU 240 and NIU related functionality. The NIU driver component of INCA performs a variety of functions: 1) controls the NIU 240 and other involved devices (e.g., DMA) to set up a transfer of network communicated data 290 from the NIU 240 to computer memory 260; 2) manages the NIU to computer memory transfer 241; 3) demultiplexes incoming network messages to the proper recipient (i.e., application) 251; 4) provides protection of network communicated data from different applications 261; 5) transfers the network communicated data 281 to the application program memory address space 270; 6) interfaces 205 to the IPP loop execution software 201 to control protocol execution; 7) interfaces 207 to the API 202 to control application program network access; and 8) relinquishes any control over the NIU 240 upon completion of message handling 241. These eight functions are performed by the INCA NIU driver component for reception of network messages. In the case of the transmission of network communicated data from one computer to another computer over a network, the eight functions are performed in reverse order.

To add the INCA NIU driver to the host computer system, the OS or application calls the “inca_attach” routine. Similarly to detach the driver from the kernel or application, the “inca_detach” routine is called. These and the other entry points to the driver, the “inca_ioctl” and the “inca_mmap” entry points, are defined in the INCA NIU driver. The NIU driver employs the existing OS kernel utilities to achieve the memory mapping of the network message buffer to the application message data buffer. The INCA NIU driver can be viewed as bypassing some existing OS functionality by replacing existing message handling functionality with a higher performance set of functions. The NIU driver is a multithreaded module that runs as a lightweight process. There are two ways in which network communicated data can be transferred from the NIU to the host computer main memory 250, DMA and programmed I/O.

In the case of DMA transfers of network communicated data between the NIU and computer memory 251, the INCA NIU driver software component sets up memory and NIU addresses, message buffer sizes/alignments/addresses, and signals the start and completion of every transfer 241. If an error occurs, the INCA NIU driver attempts to resolve the error through such actions as reinitializing a DMA transfer or repeating transfers. At the completion of DMA transfers, the INCA NIU driver releases control of any DMA and NIUs, releases any allocated message buffer memory 261, and ceases execution.

In the case of programmed I/O, the CPU transfers every byte of network communicated data from the NIU to computer memory. The INCA NIU driver provides the necessary parameters, memory and NIU addresses, transfer sizes and buffer sizes/alignments/addresses 241 for the CPU to transfer the network communicated data to computer memory 250. The best method to employ for data transfer between the NIU and the host main memory depends on the design and characteristics of the NIU and the host computer system. Some NIUs do not support DMA and hence, programmed I/O has to be employed. Both of these implementation techniques are available through the INCA NIU driver.

In an INCA implementation with the Linux OS, a 3-COM 100 Mbps Ethernet card and a Pentium based PC, programmed I/O was employed. On a Sparc CPU based Sun Microsystems workstation with the Solaris OS and the SBus 100 Mbps Ethernet adapter, DMA was employed. The INCA NIU driver works with multi-threaded OS kernels. With multi-threaded OSs, the driver routines could be called by the different threads in the kernel. As a result, the INCA NIU driver program functions like any multi-threaded program, when sequential execution of procedures are needed, the procedures are enclosed within mutual-exclusion locks. The NIU driver includes lock management to avoid deadlocks and negative OS kernel performance impacts. The INCA driver data structures are essentially kernel data structures and therefore they are carefully designed and efficiently used. Memory allocation within the driver does not lead to memory leaks. Memory mismanagement leading to kernel panics is avoided.

The INCA NIU driver can be subdivided into two functionally different modules. The first module is the normal device specific functions of the NIU driver. This module includes functions to make the module a loadable module, setting up the NIU registers and the DMA transfer and setting up the interrupts and the data structures needed for the normal functioning of the driver. The second module includes the INCA specific functions. Most of these features were implemented as pre-existing, COTS OS I/O control functions (ioctl) functions. The ioctl driver can be accessed from the user level to control the driver properties. In the case of INCA, the ioctl driver is used to setup the data space for the network message buffers and the data structures needed to synchronize the image of the network buffers between the kernel and the application memory locations. This module also included the INCA transmit and receive subsystem which were used to transmit data from the application address space and to move the received data to the application receive buffers.

The second INCA NIU driver module synchronizes the application and OS network data buffers, manages the mapping of these two address spaces to each other and manages the corresponding data structures. The application uses this INCA NIU driver module to setup a unique mapping before the INCA Driver can transfer data to that application. The INCA library functions are used to create unique network data addresses for the application inside the application memory address space. These network communicated data addresses are mapped on to the user space on creation. This feature is supported by existing operating systems' DDI/DDK interfaces and is the mmap system call for mapping pages from kernel space to user space. The INCA driver is implemented with this feature so that the virtual memory footprint is the same for the communication subsystem, assuring interoperability with existing OSs. The communicating entities therefore have the communication buffers in the user memory address space, instead of the OS space.

The INCA NIU driver can be made to auto-detect the type of NIU and load the INCA NIU driver for the specific NIU detected. This could be made either part of the INCA NIU driver component or distributed as a separate helper application for INCA installation.

Driver Entry Points

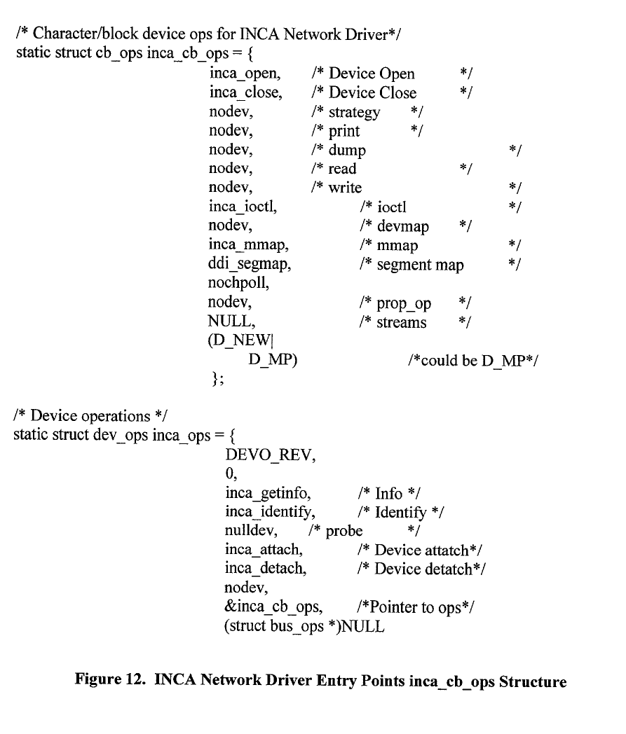

The INCA NIU driver entry points of interest are open, close, ioctl, and the mmap entry points defined in the inca_cb_ops structure in FIG. 12. The entry points for a device driver are the points or routines that can be called, or that get called by using OS function (or system) calls. The open ( ) system call on the NIU results in the invocation of the inca_open ( ) function in the INCA driver by the OS. The entry points can be used by the application using OS calls to access the NIU and also to control the unit. The ioctl ( ) system call can be used to control the different functionalities of the NIU and also to fine-tune the performance. The open entry point for INCA NIU driver is the inca_open ( ) function. The inca_open ( ) opens the INCA Driver NIU for the application to use.

The INCA library functions are used by the application to open the NIU. The opening of the NIU is transparent to the application. The inca_open ( ) routine allocates an OS data structure for the INCA NIU opened, and returns a file descriptor, which can be used to access the device for other operations on the device. The inca_close ( ) entry point is called when the close ( ) OS call is called by the application with the file descriptor obtained from a previous open ( ) OS call. The inca_close ( ) does a number of housekeeping chores. It releases all allocated memory. Any OS memory that is not released will be a drain on the system resources and could lead to an unreliable driver. The pending timeout operations pertaining to that particular device are canceled. All the mutual exclusion locks acquired after the open of the device are released. The memory allocated for the INCA network communicated data addresses inside the application's address space and OS message buffers are released. The DMA descriptor allocated for the network communicated data is released. The number of bytes being freed is equal to the number of bytes that were initially allocated. The inca_mmap ( ) entry point is invoked by the OS on a mmap ( ) system call and also whenever a pagefault occurs. The mmap ( ) entry point should return the pageframe number for the OS address space of the NIU memory at the offset requested by the system call. The inca_mmap ( ) entry point uses the DDI/DDK function hat_getkpfnum ( ) routine to return the pageframe number of the device memory address. The address returned by the mmap ( ) system call effectively maps the OS address space at the offset specified for the length specified to the address returned, in the application address space for the length specified. The mmap ( ) entry point checks whether the offset specified is a valid offset and is within the device memory.

The existing host computer OS 220 therefore performs virtual memory management through the use of a memory mapping function 281 such as the UNIX OS mmap ( ) function which maps the message buffers 261 in OS memory space 260 to the application program memory space 270. Virtual to physical address translations are therefore handled in the existing OS manner. To enable the OS 220 to perform virtual memory management and address translation 281, which provides interoperability, the INCA NIU driver must allocate message buffers 261 in the OS memory address space 260 initially, as well as in the application memory address space 270 to allow the OS 220 to make the required mappings and perform its virtual memory management functions. The INCA driver performs these functions as soon as the message arrival signal 242 is received by the INCA driver. The address locations of the message buffers 261 containing the network communicated data are therefore mapped to the virtual memory locations in the application program space 271, with only one physical memory location, hence no copying of the network communicated data is required. The ioctl ( ) entry point is a very important entry point as far as the INCA NIU driver is concerned and is implemented with the inca_ioctl ( ) driver routine. The ioctl ( ) entry point contains encoded options that can be used to carry out specific functions. The ioctl ( ) functions that are essential include the creation of network communicated data addresses for the application in the OS address space and then mapping the addresses back to the application address space, giving the application access to the network communicated data structure values. With these values, the application synchronizes the memory image between the OS and the application network buffers. The memories allocated have to be de-allocated when the NIU is no longer being used.

OS-Application Memory Mapping

The INCA architecture bypasses the OS functions in the active data path from the Network Interface to the application address space. This is implemented by using the memory mapping mechanism that is supported by character types of host computer devices. The kernel network buffer and the application address space have to be mapped so that they point to the same physical memory, to make application level manipulation of the network buffer possible. More than one application could be using the network interface and each application should be given an equal share of the network resources. The network buffers of different applications using the network interface have to be mapped with separate memory regions in the kernel so that the trusted and secure multiplexing/demultiplexing of packets is possible. The INCA NIU driver therefore contains a synchronization mechanism to synchronize the user application and the INCA NIU driver.

The INCA NIU driver also contains an identification mechanism for identifying the different applications using the network interface. The INCA mapping of the application and OS network data message buffer address spaces and the associated data structure, provide the synchronization and identification mechanisms. In order to make the mapping from the OS space to user space easier and in order to avoid implementing more memory management functionality into INCA, the message buffers are “pinned” or assigned to fixed physical memory locations in either the application or OS address space. The application specifies message buffers using offsets in the buffer region, which the NIU driver can easily bounds-check and translate.

By using fixed physical memory locations, the INCA NIU driver will not issue illegal DMA access. Fixed or “pinned” message buffer locations are not required in order for INCA to perform buffer allocation and memory location mapping. All buffers may be part of a system-wide pool, allocated autonomously by each domain (e.g., applications, OS), located in a shared virtual memory region, or they may reside outside of main memory on a NIU. Physical buffers are of a fixed size to simplify and speed allocation. The INCA NIU driver memory management is immutable, it allows the transparent use of page remapping, shared virtual memory, and other virtual memory techniques for the cross-domain transfer of network communicated data. Since INCA has complete control over the size, location, and alignment of physical buffers, a variety of buffer management schemes are possible.

The memory mapping between the OS communication segment and the application communication segment is done using the mmap ( ) system call and the inca_mmap ( ) entry point. The mmap ( ) system call returns a pointer to the communication segment in the OS, which can be used by the application to set-up the user-level descriptors to the communication segment. The user and kernel network communicated data structures hold the descriptor values corresponding to the mapped memory. These descriptors occupy the same physical memory and hence any change in one descriptor value in either kernel space or user space, will be visible from the other address space. This allows for the management of the shared memory. The hostmembase member of the kernel network communicated data structure contains the aligned base address of the mapped memory. The buffer_area member of the user and the kernel network communicated data structures contain the base address of the free communication buffers, available for receive and transmission of data. The mmap ( ) system call returns the pointer to the kernel communication segment pointed to by the hostmembase member. Virtual copying with the mmap ( ) function is used to make domain crossings as efficient as possible, by avoiding physical memory bus transfer copying between the OS 221 and application program memory address space 281.

The application can then construct the mapping descriptor values from this base address. The user network data/mapping structure is used to manage the communication segment from the application address space. The user network data/mapping structure contains pointers to the receive, transmit and free buffers and they are used to manipulate the communication segment from the application. These descriptors are synchronized with the kernel network data/mapping structure of the communication segment. Hence any modification of these descriptors in the application address space will directly effect the descriptor values in the kernel network data/mapping structure. Thus when the application needs to transmit, it acquires a free descriptor in the communication buffer, and uses this buffer to store the data it wants to transmit.

The INCA library performs the standard (i.e., IP, TCP/UDP, XTP, etc.) protocol processing, generates the headers for the packet, and then setup the transmit descriptor to point to this buffer region. This will be detected by the kernel network data/mapping structure transmit sub-system, and the OS uses DMA or programmed I/O to transfer the data directly out of the mapped communication segment. Similarly in the case of reception, the kernel network data/mapping structure sub-system acquires a free descriptor and then copies the received data into the free buffer and updates the receive descriptor in the kernel network data/mapping structure. This is detected by the user network data/mapping structure receive subsystem and is handled by the INCA Library receive routines.

The kernel network data/mapping structure is similar to the user network data/mapping structure, except that it contains extra members to handle the communication segment in the kernel address space. The size of the segment and the DMA descriptors are required for setting up DMA and also proper management of the mapped communication memory. The communication descriptors in the kernel network data/mapping structure correspond directly to the user network data/mapping structure communication descriptors. The buffers are identified and managed with respect to the base buffer_area member in the user (application) and OS (kernel) network data/mapping structures. The buffer_area contains the base pointer to the communication segment and all the other members hold values, which are offsets from this base address. All the addresses that these communication descriptors can hold are within the communication segment address space.

Message Addressing/Multiplexing/Demultiplexing

Network communicated data is received or transmitted using standard network protocols such as IP, TCP, UDP, etc. International standard protocols contain addresses of the target host computer, the application(s) within the host computer, and sometimes separate addresses for concurrent, separate exchanges with the same, singular target application. INCA performs the addressing/multiplexing/demultiplexing of network messages to/from the addressed host computers and target applications using the INCA port abstraction. Not all applications on a machine may be using the INCA software to communicate over the network. There may be a mix of INCA and non-INCA communicating applications in which case the INCA NIU driver 200 must also route messages to the non-INCA NIU driver 221 or the non-INCA protocol processing software 230, or to some other non-INCA software. The INCA NIU driver 200 maintains a list of INCA application program addresses as a part of the network data/mapping address data structures.

When the application uses the INCA library and the INCA NIU driver to access the network, it first sets up a mapping between the network buffer in the application space and the kernel buffer and creates the data structures to manage the buffers, namely the network data/mapping and the channel. The INCA network data/mapping and the INCA channel are used to access the application specific buffers. Each channel corresponds to a separate connection with the same or a different destination. The channel abstraction is necessary for implementing distributed computing over a network. The channel multiplexing takes place after the network data/mapping address multiplexing takes place. The INCA NIU driver carries out the channel management in INCA and each connection is assigned a channel from the maximum available channels.

Each channel corresponds to a different destination address. It is possible to have channels with the same destination-source address pairs, but they are assigned to a different network data/mapping address in the same application. The INCA Channel is implemented to maintain interoperability with existing NIUs, protocols, OS's and application programs. Unlike the U-Net Channel data-structure where each channel contains a physical address and an U-Net port both of which must be communicated apriori via some “out-of-band” communication mechanism, the INCA Channel uses the standard Internet ARP (address resolution protocol), RARP (reverse address resolution protocol), ICMP (Internet control message protocol), DNS (domain naming service) and optionally IP Options protocol fields and address information to perform network data/mapping of network messages to the proper host machines, applications and OS/application message buffer memory locations.

In U-Net and other Active Message based architectures (e.g., Osborne Patent), the port is an eight bit number that is used to identify the network data/mapping addresses to or from which the data has to be received or transmitted. An Ethernet protocol header is 14-bytes wide. For IP traffic, the 13-14 bytes contain the value “0” and “8”. The U-Net and Osborne Patent architecture's port uses the 14^{th} byte in the Ethernet header. This would cause the data packet or network message to not be transmitted by an IP router or switch. The U-Net and Osborne Patent architecture can therefore not operate over a general purpose network, Internet or other network. INCA uses the 14-byte header that is the normal Ethernet header, with IP protocol identifier and the source and destination addresses verses the custom 16-byte header communication messages of the U-Net, Active Message and Osborne architectures.

Since INCA is an interoperable architecture, the Ethernet header cannot be changed. The INCA NIU driver implements channels and ports for addressing/multiplexing/ demultiplexing of messages using the standard Internet ARP, RARP, ICMP, DNS and optionally IP Options protocol fields and address information. As a result, INCA provides complete interoperability with existing network routers, switches, communication protocols so that the network data/mapping addresses can be identified and standard network protocol messages pass through network routers and switches without being rejected. The INCA Channel contains the port numbers for transmission and reception. The INCA port contains an identifier that identifies the network data/mapping to use for that particular port. When a packet is received by the INCA Network interface, it multiplexes the packet to the network data/mapping corresponding to the port identifier in the received packet. The port is mapped to the corresponding network data/mapping addresses using the INCA port data structure in the INCA Driver. When a packet is received at the network interface, the INCA receive routine, multiplexes the packet to the network data/mapping addresses corresponding to the mapping for that port.

To assure that only the correct applications access the message data, application program identifiers to network data/mapping addresses and network data/mapping addresses to message data mappings are maintained. An application can only access message data in the network data/mapping address data structure message queues where the identifiers of network data/mapping address data structure(s) of message queues matches the identifiers of network data/mapping address data structures for that application. Any access to network communicated data must come from the intended recipient application or in the case of transmitting network communicated data, access to the network communicated data must come from the transmitting application. If there are no network data/mapping addresses mapped to that port, the packet is dropped. The multiplexing allows for a secure environment for the reception of packets. This also protects from any spurious processes accessing the packets meant for other processes.

Since the network data/mapping addressing is created in a secure environment, the INCA architecture provides for a protected domain for protocol processing at the user level. The mapping between the port and the corresponding network data/mapping addresses is done by the INCA Driver and is stored in the device node, which is not accessible by any user processes. Since the packet is directly multiplexed to the user application communication segment, the application does not need to carry out any further multiplexing in the INCA architecture as the protocol processing takes place in an integrated environment.

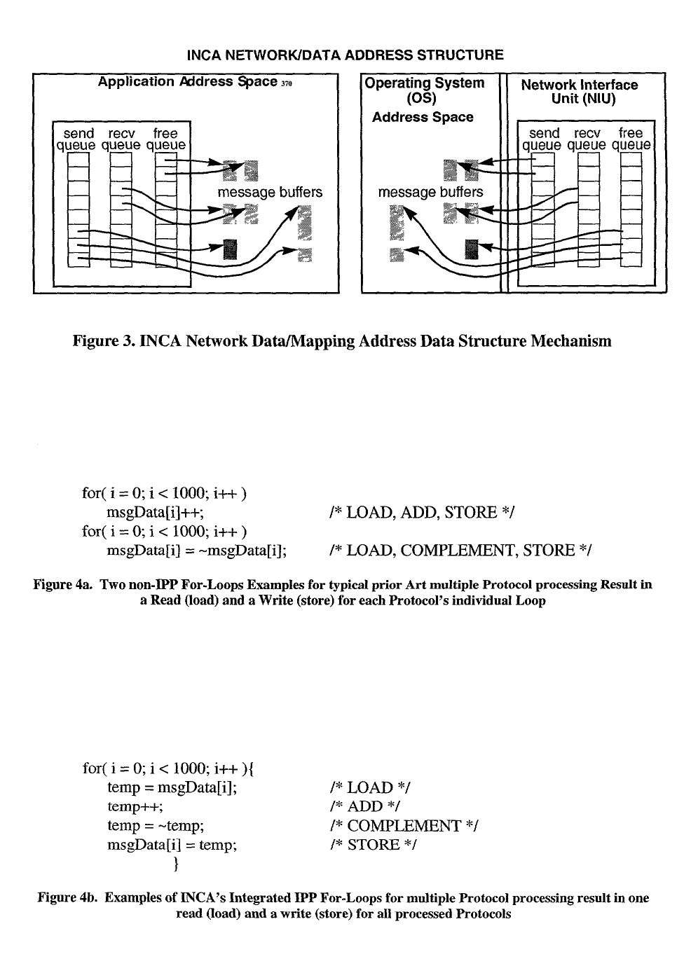

Referring to FIG. 3, an overview of the network data/mapping address data structure mechanism is shown. Network data/mapping address data structures 300 bear some resemblance to conventional sockets or ports. A separate network data/mapping address data structure is established and maintained for each application and each network connection for each application. For applications without INCA network data/mapping address data structures, non-INCA networking applications, the INCA NIU driver passes the message arrival notification to the non-INCA NIU driver.

Each application that wishes to access the network first requests one or more network data/mapping address data structures 300 through the INCA alternative API calls. The INCA NIU driver then associates a set of send 301, receive 302, and free 303 message queues with each network data/mapping address data structure through the use of two INCA API calls, inca_create_ndmads ( ) [network_data/mapping_address_data_structure] and inca_create_chan ( ). The application program memory address space contains the network communicated data and the network data/mapping address data structure message queues (network data/mapping address data structure send/receive free queues 301, 302, 303) which contain descriptors for network messages that are to be sent or that have been received. In order to send, an application program composes a network message in one or more transmit buffers in its address space and pushes a descriptor onto the send queue 301 using the INCA API calls. The descriptor contains pointers to the transmit buffers, their lengths and a destination tag. The INCA NIU driver picks up the descriptor, allocates virtual addresses for message buffers in OS address space (using the OS) and sets up DMA addresses. The INCA NIU driver then transfers the network communicated data directly from the application memory space message buffers to the network.

If the network is backed up, the INCA NIU driver will simply leave the descriptor in the queue and eventually notifies the user application process to slow down or cease transmitting when the queue is near full. The INCA NIU driver provides a mechanism to indicate whether a message in the queue has been injected into the network, typically by setting a flag in the descriptor. This indicates that the associated send buffer can be reused. When the INCA NIU driver receives network communicated data, it examines the message header and protocol header addresses and matches the information with the message tags to determine the correct destination network data/mapping address data structure. The INCA NIU driver then pops free buffer descriptors off the appropriate free queue 303, translates the virtual addresses, transfers the network communicated data into the message buffers in OS address space, maps the memory locations to the application address space and transfers a descriptor onto the receive queue 302.

Each network data/mapping address data structure contains all states associated with an application's network port. Preparing an network data/mapping address data structure for use requires initializing handler-table entries, setting an network data/mapping address data structure tag, establishing translation table mappings to destination network data/mapping address data structures, and setting the virtual-memory segment base address and length. The user application program uses the API routine calls “ioctl ( )” and “mmap ( )” to pass on any required network data/mapping address data structure data and provide the virtual memory address mapping of the OS message buffers to the application memory address space locations. Once this has been achieved, the user application is prepared to transmit and receive network communicated data directly into application memory address space. Each network data/mapping address data structure 300 is associated with a buffer area in contiguous physical memory and holds all buffers used with that network data/mapping address data structure.

Message descriptors contain offsets in the buffer area (instead of full virtual addresses) that are bounds-checked and added to the physical base address of the buffer area by the INCA NIU driver. In summary, network data/mapping address data structures and their associated INCA NIU driver API calls set up an OS-Bypass channel for routing network communicated data address locations to and from memory to the correct applications.

Rx and Tx Functions

The INCA NIU driver contains special receive and transmit functions to facilitate transmission and reception from the mapped communication segments. In ordinary NIU drivers supporting IP, the IP module in the kernel will push the IP packet into the network buffers and start-up the transmit process in the kernel driver. Similarly, when a packet is received at the network interface, if the Ethernet protocol identifier is an IP identifier, the packet is copied into the IP module buffers. Since the INCA network buffers are accessed at the user level, this method of functioning is not possible with the INCA NIU driver.

In the INCA driver, the transmission subsystem has to look at the transmit descriptors to find out if a packet is ready for transmission, and if it is ready, has to set-up the DMA or programmed I/O transfer of the packet to the NIU. In the case of reception, the INCA receive routine has to check if any application is waiting for the packet and then copy it from the NIU buffer to the communication segment corresponding to that application. The INCA network data/mapping address descriptors have to be modified to point to the next received descriptor. In addition, the bounds of the descriptor rings have to be checked each time a transmission or reception takes place. The communication buffers are cyclic buffers and are looped through. The communication segment is set-up such that packets can be transferred (via DMA or programmed I/O) to and out of the communication segment directly. Hence there is essentially only one copy in the transmit data path. In the case of reception, the packet is copied onto to the free descriptors in the communication buffer. This essentially implements single copy architecture. In the case of TCP implemented with the INCA NIU driver, TCP data buffering takes place and hence INCA TCP is a two copy communications architecture.

Control and management of transferring network communicated data from the NIU to internal computer memory (i.e., RAM), or some other type of memory (e.g. cache, hard disk) 241, 251, are initiated when a message arrives at the computer from a network connection. The NIU hardware signals the arrival of a message, typically a hardware interrupt 242. The message arrival notification signal is received by the INCA NIU driver software 200. Upon receipt of a message arrival notification, the NIU driver takes over control of the NIU (e.g., Asynchronous Transfer Mode (ATM) network card) 240, and sets up the registers, firmware, etc., of the device to transfer the message from the device to main memory 241, 251.

Memory Management

INCA Memory management essentially involves managing the communication segment, and the free and used buffers in the segment. INCA memory management allows application level control of network buffers. Applications can use the INCA NIU driver memory management routines to allocate the network buffers as application memory so that network data is mapped from the OS network buffer space to the application memory space. Alignment of the buffers is also performed for efficient protocol processing. The buffer management is effected by a set of INCA NIU driver routines that allocate memory on request and periodically reclaim memory that has served its purpose. The image of the memory as seen by the kernel and the application is synchronized at all times. The buffer management involves a set of routines that are implemented in the INCA NIU driver library routines to manage the mapped communication segments. In INCA, the memory that has to be managed is the communication segment memory.

When a packet has to be transmitted, it has to be allocated a free buffer in the communication segment. Similarly, when a packet is received, it consumes a free buffer. The buffers that are consumed by transmit and receive processes have to be reclaimed when the buffers are no longer needed. To avoid data copying between the data from one buffer to another in the user space, the memory allocation for transmission needs is managed by the INCA NIU driver routines. When an application has data to send, it calls the INCA NIU driver library routine inca_send ( ). The inca_send ( ) uses the OS message buffer management by-pass memory management routines to get a free buffer from the communication segment. It then copies the data to this buffer, and passes this buffer for further data processing.

Protocol processing is carried out on the communication segment itself, so that locality of reference is maintained for maximum cache memory and processor efficiency and speed, after which the packet is set for transmission directly from the communication segment. This results in a single copy transmission of data from the user space. The INCA NIU driver 200 allocates buffer space when an application 210 calls the INCA NIU driver 200 with an INCA open ( ) call 211 which opens the INCA NIU driver 200 to initialize the DMA transfer 251. The INCA NIU driver 200 receives the NIU message interrupt signal 242 and starts the INCA NIU driver 200 which causes message buffer allocation to occur 261, 271. The INCA NIU driver 200 uses the 4 KB memory page size provided by most OS virtual memory systems 221, and allocates message buffers in 2 KB increments. Each message is aligned to the beginning of the 2 KB buffer with a single message per buffer for messages smaller than 2 KB. For messages larger than 2 KB, multiple buffers are used beginning with the first and intermediate buffers filled from start to end. The last buffer contains the remnant of the message starting from the 2 KB buffer virtual memory address position. For messages equal to or less than 2 KB, one buffer is allocated and the contents are aligned with the first byte placed at the start of the 2 KB buffer address space.

The inca_tx_alloc ( ) routine in the INCA NIU driver library implements the allocation of a free buffer within the communication segment for transmission. The routine returns a free buffer from the set of free buffers available in the communication segment. Memory buffer allocation is done in such a way and the buffers are aligned in the communication segment such that the locality of memory references is increased for efficient memory reads and writes and hence faster processing. The buffers are cyclic. The sets of free buffer serve both transmit and receive buffer requirements. The inca_tx_reclaim ( ) routine in the INCA NIU driver library reclaims the used buffers in the communication segment. Potential memory leakage within the communication segment is also taken care of by this routine.

To implement aligned memory transfers for efficient transmission and reception, the memory buffers in the communication segment are aligned to 2K boundaries. The INCA NIU driver library also provides memory allocation routines that will return aligned memory, which can be used by the application for its memory requirements. The inca_rx_reclaim ( ) routine reclaims the buffers used by the receive sub-system and adds to the set of free buffers. When a packet is received at the network interface, the INCA Driver receive routine consumes a free descriptor in the communication segment and allocates it to the receive descriptor. This results in the changing of receive descriptor, which is detected by the user network data/mapping addressing receive descriptor in the application. The application processes received the data packet in the communication segment and once it is done with the processing, pushes the packet to the set of free buffers. This has to be reflected in the kernel data structures for the communication segment. This is implemented by the reclaim routines which effectively pushes the buffer to the set of free buffers and updates the user network data/mapping addressing structure for receive and free buffers, which are also reflected in the kernel network data/mapping addressing. Similarly when transmit sub-system acquires a free buffer and is done with processing, it has to be returned to the set of free buffers. The user network data/mapping addressing data structure is modified and this will be reflected in the kernel network data/mapping addressing data structure.

Once network communicated data is available in the computer's memory, the INCA NIU driver notifies the IPP software that network communicated data is available for protocol processing. The notification includes passing a number of parameters to provide needed details for the IPP software. The parameters include the addresses of the network communicated data and the network data/mapping address data structures to determine the recipient application program.

INCA IPP

The INCA IPP component is a software module that integrates standard network protocol processing into one multithreaded module that runs as a Lightweight process. In INCA's IPP component, protocol processing is implemented in an integrated processing loop. INCA IPP involves not just integrated processing of the layers of protocols, but includes the protocol setup designed to yield maximum locality of memory execution time performance improvement at each stage of the processing together with the INCA NIU driver functions. The processing of all data touching functions is done together in one go by taking N bytes at a time, where the value of N is decided depending on the number of layers that are integrated into the loop and their interaction. N can also be the size of the host computer's CPU word. The interaction between the different protocols is taken into account in protocol processing, and the loop is designed to provide the best locality of memory references.

Networking involves intensive processing on data with very limited locality or no locality at all because of the basic design of the protocols and their implementation. An example is Internet checksumming, where the data has to be touched by each layer in the protocol hierarchy. This data touching by each layer takes place independent of the other layers, and results in the same set of data and hence memory locations being accessed more than once. This results in loss of memory reference locality as data packet traverses from one layer to the other in the hierarchy and increases the cache misses, increasing the CPU processing time required for protocol processing. INCA performs all data processing functions for all protocols on the data where the data is read into the CPU once and after all processing is complete, the data is written out to the message data buffers. The number of reads and writes of network communicated data is greatly reduced, decreasing the amount of time a CPU waits for memory to be loaded with the correct data and instructions.

INCA's IPP loop performs protocol processing in much less time than current architectures. Unlike other present art in this realm (including the Osborne Patent), INCA's IPP loop processes standard network protocols such as IP, TCP, UDP, XTP, etc. providing interoperability with existing networks, NIUs and application programs. INCA's IPP includes protocols above the transport layer, including presentation layer and application layer protocol processing, and places the IPP loop into one integrated execution path with the INCA NIU driver and INCA API software. In current systems, communication protocol processing is conducted as a part of and under the control of the OS in OS memory address space. Each protocol is a separate process requiring all the overhead of non-integrated, individual processes executed in a serial fashion. Protocol execution by the existing OSs and under the control of the OS are not used by INCA's IPP component. INCA's IPP performs protocol execution using the INCA software library implementations of the protocols either in the OS or linked to the application in the application program memory address space. The knowledge of the processor and the OS can be employed to enhance the performance even further. Such a hard-wired implementation, writing the software for the specific features of the processor and the OS, will cause the implementation for one processor and one OS to not work efficiently on another processor and another OS.

The loop strives for maximum locality of memory reference in its processing. The integrated loop implementation has three basic goals in support of achieving maximum locality of memory references: 1) integrate the data manipulation functions, 2) integrate control functions and 3) integrate the above two functions with the INCA NIU driver and INCA API. The loop performance depends on the processing unit of the loop. The processing unit is decided based on the number of functions that need to be integrated. If External Data Representation (XDR) presentation protocol processing is included in the loop, then the processing unit has to be 8-bytes because the XDR data unit is 8-bytes long.

The case with Data Encryption Standard (DES) encryption protocols/algorithms is similar in that the protocols used may limit the maximum data unit length to something less than the word size (optimum processing unit size) of the CPU. In order to maintain interoperability with existing protocols, INCA IPP does not alter the functionality of existing protocols. Existing protocols require some out-of-order processing. As a result, the IPP loop does not encompass all the existing protocol functions due to protocol out-of-order processing specification limitations. INCA maintains interoperability at the expense of additional loop integration. The INCA IPP loop is kept as simple as possible. The INCA IPP loop can be extended to include any and all combinations of existing and future protocols, including encryption. With presentation protocol type functions, or functions requiring many data touching operations, like encryption, the INCA IPP loop provides large performance gains over current OS protocol processing. FIG. 4a depicts a “C” code example of typical protocol processing code. Before the code can be executed, the network communicated data must be copied to each protocol's memory address space. When the code is compiled to run on a RISC CPU, the network message data manipulation steps results in the machine instructions noted in the comments. First, the protocol software process, e.g., the IP software, is initialized and the network communicated data is copied from the OS message buffer memory area to the IP process execution memory area. Each time a word of network communicated data is manipulated, the word is loaded and stored into memory. Upon completion of the first protocol, the second protocol process, e.g., TCP software, is initialized and the network communicated data is copied to this protocol's execution area in memory.

Once again, each time a word of network communicated data is manipulated, the word is loaded and stored. This process continues until all protocol processing is complete. In FIG. 4b, the INCA system with the IPP method is shown, where each word is loaded and stored only once, even though it is manipulated twice. Each protocol's software execution loop is executed in one larger loop, eliminating one load and one store per word of data. This is possible because the data word remains in a register between the two data manipulations. Integrating the protocol processing for-loops results in the elimination of one load and one store per word of network communicated data. The RAM- cache level n pipeline is filled with the correct data and instructions, greatly reducing cache misses and the associated memory pipeline refill times. The IPP method of performing all protocol processing as one integrated process, also eliminates the copying of all network communicated data between the initialization and completion of each separate communications protocol used (e.g., copying the data to IP protocol address space, then copying the data to UDP or TCP protocol address space, etc.).

The IPP component divides protocol processing of network messages into three categories: data manipulation—reading and writing application data, header processing—reading, writing headers and manipulating the headers of protocols that come after this protocol, and external behavior—passing messages to adjacent layers, initiating messages such as acknowledgments, invoking non-message operations on other layers such as passing congestion control information, and updating protocol state such as updating the sequence number associated with a connection to reflect that a message with the previous number has been received.

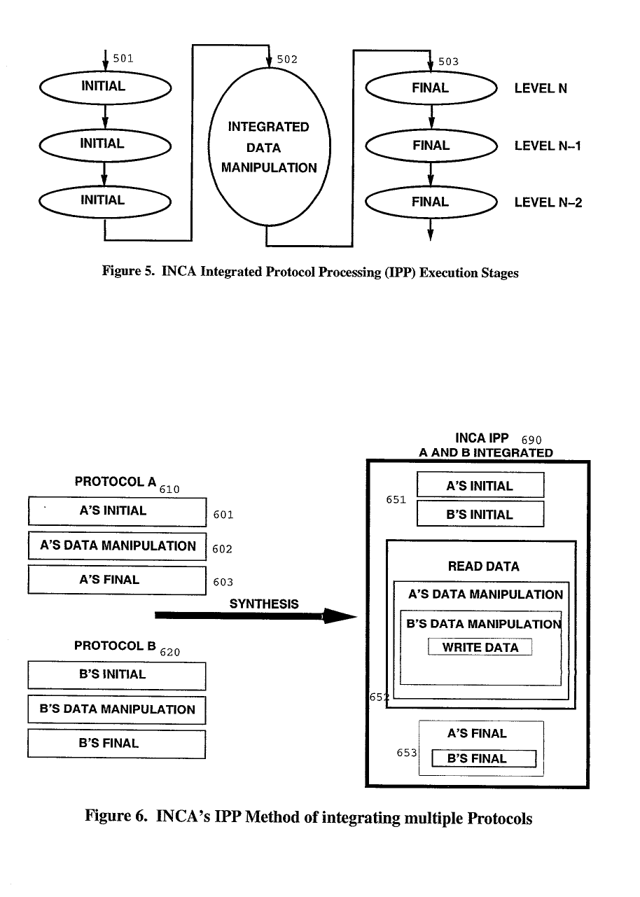

Referring to FIG. 5, the INCA IPP component executes the protocols in three stages in a processing loop: an initial stage 501, a data manipulation stage 502 and a final stage 503. The initial stages of a series of layers are executed serially, then the integrated data manipulations take place in one shared stage and then the final stages are executed serially. Interoperability with existing protocol combinations such as IP, TCP, UDP and XDR combinations requires the IPP software to contain some serial protocol function processing of the network communicated data in order to meet the data processing ordering requirements of these existing protocols. Message processing tasks are executed in the appropriate stages to satisfy the ordering constraints. Header processing is assigned to the initial stage. Data manipulation is assigned to the integrated stage. Header processing for sending and external behavior (e.g., error handling) are assigned to the final stage.

Referring to FIGS. 5 and 6, INCA's IPP method of integrating multiple protocols is shown. The protocols of protocol A 610 and protocol B 620 are combined and INCA's IPP method integrates the combination of protocol A and B 690. The initial stages 651 are executed serially 501 (as shown in FIG. 5), then the integrated data manipulation 502 is executed 652, and then the final stages 653 are executed serially 503. Executing the tasks in the appropriate stages ensures that the external constraints protocols impose on each other cannot conflict with their internal constraints.

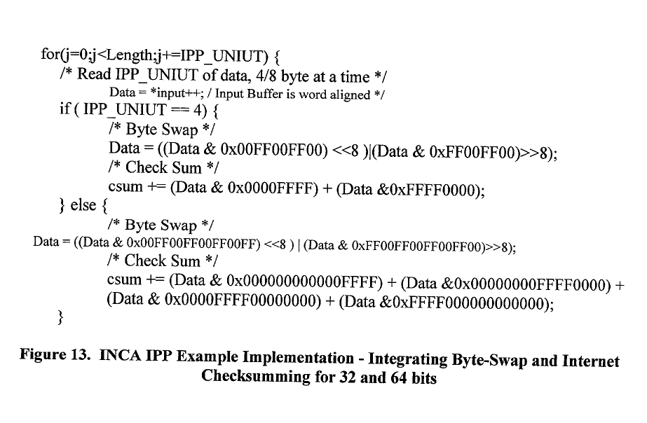

FIG. 13 depicts an implementation example of the integrated approach to data touching functions. The checksumming of the IP and the TCP/UDP protocols is integrated to include the bytes that both use, such as the pseudo-header checksum for the TCP/UDP. Macros are used to implement inlining for increased processing speed. These macros are integrated into the loop with byte-swapping and presentation functions. Integrating the control functions is done to a certain extent. Out-of-order control information processing is done. This is done to exploit the advantages of locality of memory references whenever possible. Since the protocols in the TCP/IP stack were not designed to support IPP, in many cases integrating control function processing is not possible, and could sometimes even lead to performance problems. A good example would be when an UDP packet is fragmented, so that IP has to perform processing on the fragments, but UDP processing could start only when the fragments are re-assembled. In such cases, there are two options that could be chosen. One option is to perform sequential processing for fragments and the other option is to perform integrated processing on the re-assembled UDP packet. It is trade-off for efficiency as to which one of the above to implement. The IPP loop reads in CPU word size bytes at a time. The checksum and byte-swap is implemented in the loop. The INCA IPP software uses an optimized protocol checksum processing routine that calculates checksums on a word (e.g., 4 to 8 bytes depending upon the machine) of network communicated data at a time, rather than the existing method of one byte at a time.

INCA's IPP checksum calculation is roughly four times faster than existing checksum calculations. For small message sizes of less than or equal to 200 bytes, which comprise some 90% or more of all network messages, INCA's IPP checksum routine greatly speeds up the processing of small messages since checksum calculation is the majority of calculations required for small messages. An implementation was done on a Sun UltraSparc-1 host computer running the Solaris-2.5.1 OS. Since the Solaris OS is a 32 bit operating system, and UltraSparc is 64 bit processor, the IPP data processing unit was chosen as 4-bytes.

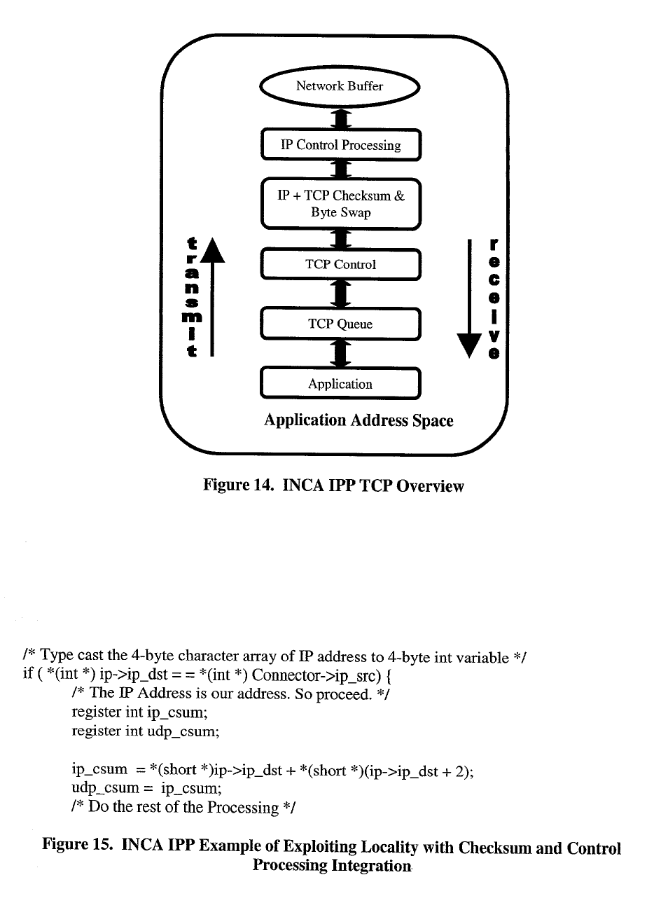

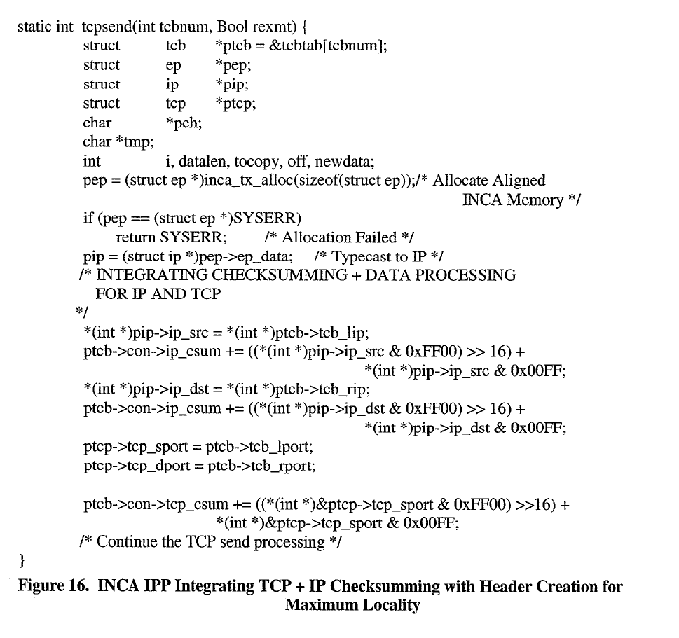

The TCP implementation of the INCA IPP is shown in FIG. 14. In the case of the TCP/IP protocol stack, there are two types of operations involved, checksumming for both the IP header and the TCP header and data, and executing the control functions of TCP and IP. The control function processing of TCP is very complex and spans out into three distinct threads in the INCA library. Control processing also involves processing of memory locations that contain data as far as the data processing functions are concerned. This is indicated in FIG. 15 where the control processing was integrated with checksumming. The INCA TCP/IP integration for the IPP loop is therefore designed in two stages. In the first stage, the control processing and the data processing functions that can be implemented together to obtain maximum memory locality are performed together. In the next stage, the data processing function execution is performed within the IPP loop. An example of this is shown in FIG. 16, where the TCP output thread sets up the header and the checksumming related to those header data segments are also carried out. In this particular example, both TCP and IP checksumming are carried out when the headers for those protocols are generated. This allows for making use of the locality interlaced between the protocols.

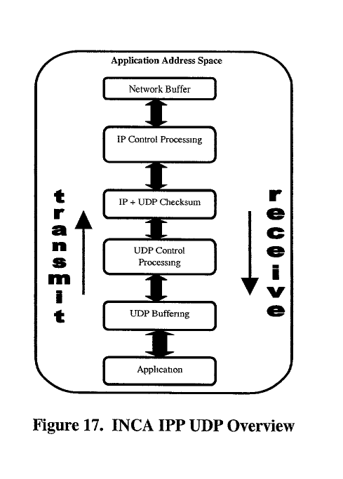

The UDP implementation of the INCA IPP is shown in FIG. 17. The UDP IPP is done as part of the INCA send routine, i.e., it is carried out in the IPP routine that does the transmit and receive side IPP loop. The IPP loop routines can distinguish between the two protocol packets that it is given, and it does processing differently. In the case of UDP, the UDP header manipulation is done by the IPP loop routines itself. This close-knit implementation of IP and UDP allows for extracting maximum locality out of the protocol processing. In the case of UDP, the protocol control functions are few and the UDP header is only 8-bytes. The UDP packet is usually offset from the IP packet by 20-bytes due to the IP header. Similar to the case of the TCP/IP integration, the generation of the UDP pseudo header is an area where checksumming can be integrated. Pseudo-headers are used in the checksumming of the transport protocols (i.e., TCP, UDP). They involve checksumming on the IP source and destination addresses, and the IP length and protocol header fields. This is included for added insulation to the checksum process so that the transport checksum also includes the underlying IP layer also.

The IPP software starts up directly after reception of network communicated data into the message buffer. It does the integrated checksumming on the network communicated data in the initial stage 501, protocol data manipulations and Host/Network byte order conversions in the middle integrated stage 502, and TCP type flow control and error handling in the final stage 503. The concept of delayed checksumming has been included in the loop. In the case of IP fragments, the checksumming is done only after reassembly. Message fragments are transmitted in the reverse order, i.e., the last fragment is transmitted first, to make the time of checksumming less in the case of UDP. Once the data processing is complete, the packets are multiplexed to the corresponding protocol ports set up by the API.

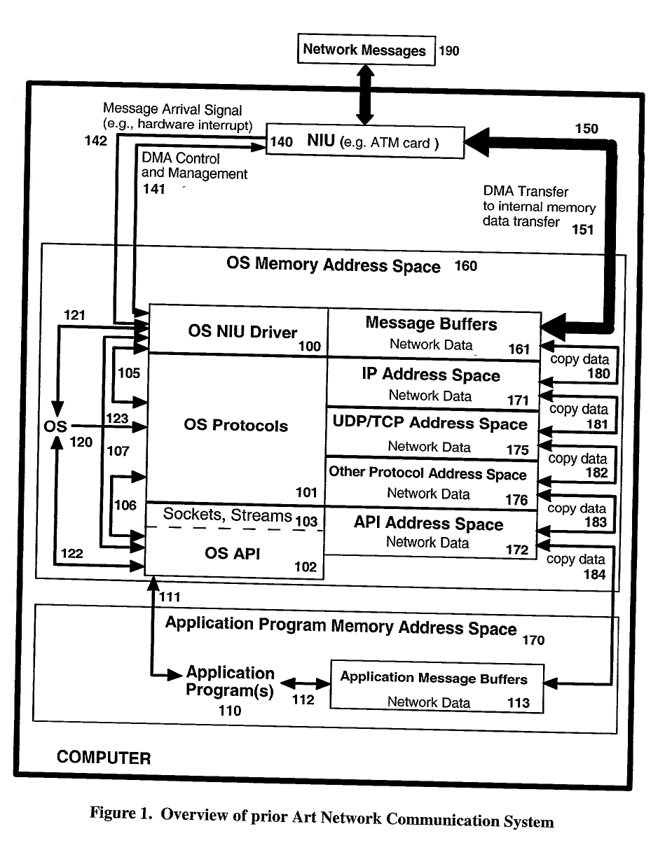

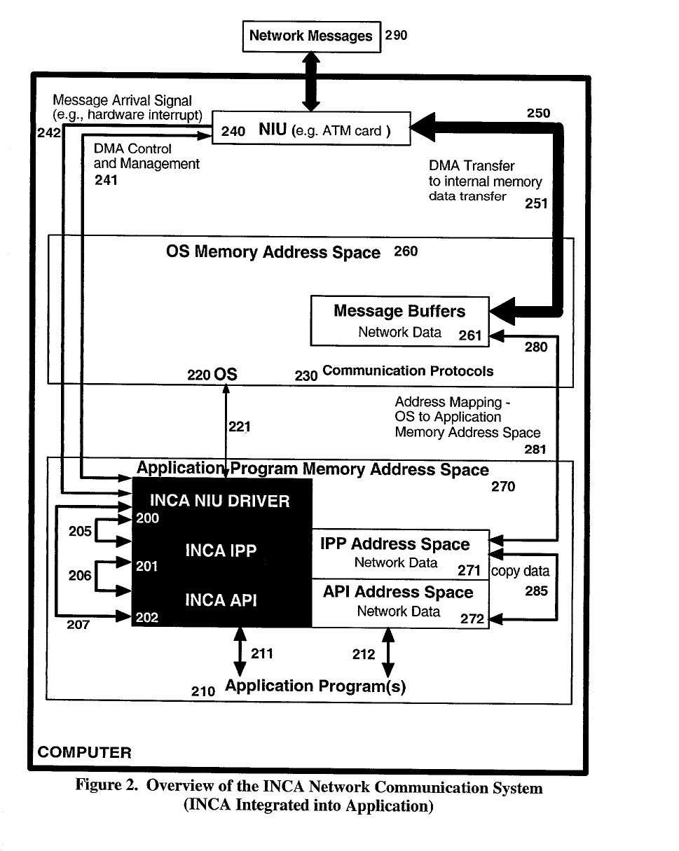

The INCA architecture allows the entire networking sub-system to be processed in one address space. Consequently, the number of copies of the network communicated data to and from memory are greatly reduced, as can be seen by comparing FIGS. 1 and 2. Additionally, the INCA architecture and the IPP loop can be extended to all the data touching functions, not just to the protocol processing functions, but to include the entire processing space. The INCA IPP provides the flexibility to add the application processing into the IPP control and data manipulation functions. This will further increase the locality of memory references and reduce the number of reads and writes to and from memory, yielding even greater network communicated data rates as seen by the application.

Applications can add their own functions into the IPP loop, linked dynamically at run time, to enhance the capabilities of the INCA IPP loop features and its extensibility. Interoperability requires the IPP loops to use and execute existing protocols as well as future protocols. The INCA software libraries accommodate the integration of all existing protocols and future protocols into the IPP component of INCA and provide integration with the INCA NIU driver component functions.

INCA API

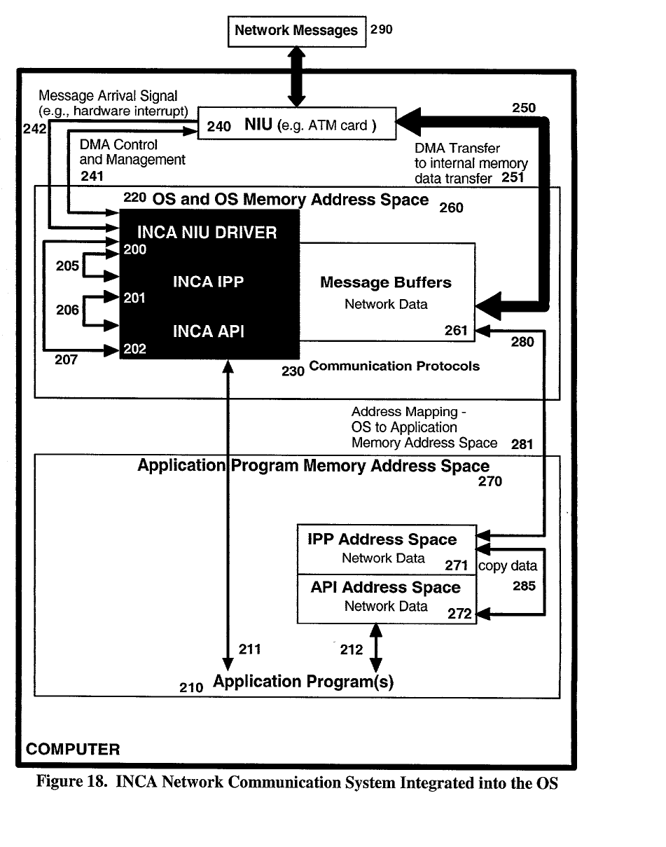

The INCA API component of the INCA library provides the interface between applications and OSs and INCA. The API provides the application the link to utilize the INCA high performance network communication subsystem as opposed to using the existing system API and existing network communicated data processing subsystem. The existing system API could also be used to interface to the INCA IPP and INCA NIU driver components if the existing system API is modified to interface to the INCA IPP and NIU components. In an embodiment of INCA where INCA is integrated into the application, as depicted in FIG. 2, the API limits the changes required to existing application programs to minor name changes to their current API calls and thereby provides interoperability with existing application programs. In an embodiment of INCA where INCA is integrated into the OS, as depicted in FIG. 18, the INCA API is the OS API and no changes to the application program are required to utilize and interface to the INCA functionality.

The INCA API provides the application and/or OS the following functions: open a network connection by opening the NIU, specify parameters to the INCA NIU driver, specify the protocols to use and their options, set the characteristics of the data transfer between the application and the network using the INCA IPP and NIU driver components, and detect the arrival of messages by polling the receive queue via blocking until a message arrives, or by receiving an asynchronous notification on message arrival (e.g., a signal from the INCA NIU driver). The API also provides low level communication primitives in which network message reception and transmission can be tested and measured. The API is a multi-threaded set of software routines that control the basic functioning of the INCA library. Most of the functions are re-entrant. The INCA API is simple enough to provide the applications and OS easy access to the network interface without knowing any internal details of the working of the INCA architecture and the INCA software library.

The INCA API resembles the Berkeley Socket API in order to keep the interface similar to the existing system network communications API's. The socket API consists of a series of functions that the application has to call in-order to access the network. The series starts with the “socket ( )” system call. Any application that wants to use the network interface has to first use this system call before it can use the networking capabilities. This call returns a descriptor, which the application has to use in the subsequent API system calls. The main characteristics of the sockets API are that these APIs all require a number of costly OS system calls and context switches. System calls are costly in terms of processing time in that they require the system to switch from the user mode to the supervisor mode. This switching results in the flushing of data in the cache and hence loss of locality, resulting in a stalled CPU waiting for memory accesses. Context switches are also very costly because of the set of routines that the kernel has to execute to switch the context of the processor execution from the user mode to the kernel mode.

Unlike existing Berkeley-socket-like API's, INCA's API does not use system calls for the protocol processing and hence provides the applications with the maximum possible throughput with low processing delay. The INCA API does however, provide the advantages and interoperability of a socket-like API: a familiar, unified interface for all applications, hiding the details of the underlying network communications functions and portability across host computer systems and networks. The API tries to make the complexities of the INCA implementation transparent to the user. The application does not need to know anything about the underlying library implementation specifics and still can access the INCA network interface through the API calls. It can access the user-level protocol library through the INCA API calls. The API provides a direct interface to the INCA NIU driver for applications that want to use the interface directly without going through the INCA protocol library. The INCA API is flexible enough to allow the applications to use the API to make use of the full features of the INCA architecture and the INCA user-level integrated protocol implementation. INCA can also be made suitable for Intranets by implementing Intelligent LAN functionality as a second-tier layer between the INCA API and the other INCA software library components.

Although INCA's API can be located anywhere between the networking application program and any protocol of the protocol stack, the API is typically located between the application and the INCA IPP component. In current OSs, the API typically sits between the session layer (e.g., socket system calls) and the application. Ideally, the API sits between the application and all other communication protocols and functions. In current systems and application programs, many times the application also contains the application layer protocol (i.e., Hypertext Transport Protocol—HTTP), the presentation layer protocol functions (i.e., XDR like data manipulation functions), and only the socket or streams system call is the API. This is not necessarily ideal from a user perspective. By integrating presentation and application protocol functions into the application, any change in these functions necessitates an application program “upgrade” at additional procurement, installation time and maintenance cost. INCA can incorporate all the application, presentation and session (replacement for socket and streams calls) functions into the IPP loop. This can even be accomplished dynamically, at run time, through application selection of the protocol stack configuration.

The INCA API can be viewed as consisting of two parts, a set of data structures and interface calls.

API Data Structures

The INCA API consists of a set of data structures that the application has to initialize before the calls to the INCA library routines can be made successfully. The present implementation uses the structure called the inca_addr structure that has to be initialized by the application before any INCA API calls can be made. A user application has to initialize this structure for both the Local connection as well as the remote connection. An application should have at-least two variables of the type inca_addr. INCA supports automatic local and remote port assignment. An “IPaddr” field contains the pointer to the IP address.

INCA can make use of the address resolution and name resolution protocols to make IP address assignments automatically. The inca_dport and inca_sport variables are automatically initialized to the source and destination port addresses using ARP, RARP, DNS and any other address and name resolution protocols. The applications have to specify the family and the protocol to use when using the INCA API calls. IPT_UDP is the identifier that has to be used for INCA UDP protocol over IP and IPT_TCP is the identifier for INCA TCP. The INCA library supports the Internet family of protocols with the identifier AF_INET. The protocols and family must be specified in the inca ( ) API function call.

API Interface Calls

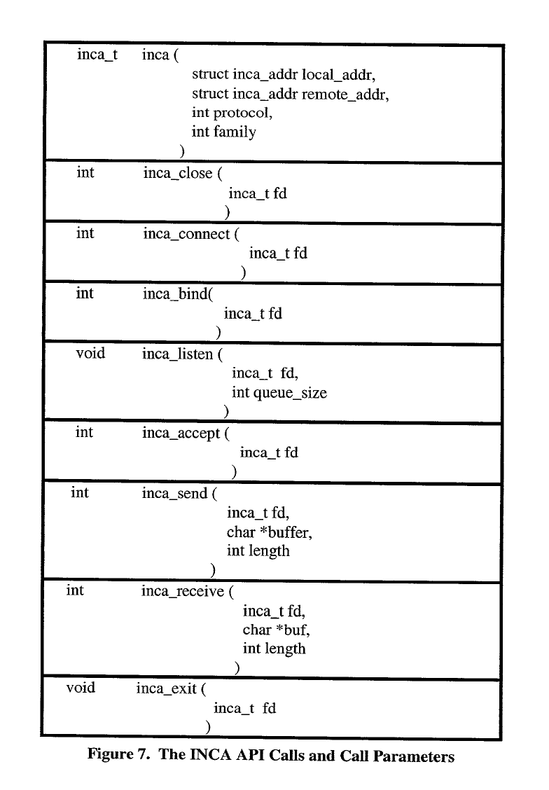

The INCA API calls available to the application and the OS are listed in FIG. 7 and described in the following sections. The INCA API calls can be used to bypass the current OS network I/O system calls: socket ( ), connect ( ), listen ( ) and bin ( ) when INCA is integrated or linked to an application(s). When INCA is integrated into or linked to a pre-existing or future OS, the functionality of the INCA API would replace the current OS API system calls. The INCA API set of calls in FIG. 7 simplify the application programming required to use the invention to renaming the existing OS API calls by placing “incas_” in front of the existing calls.

As depicted in FIG. 7, the API provides the basic commands like “open ( )”, “close ( )”, “send ( )”, “receive ( )”, etc., similar to existing system networking APIs. Parameters passed by the application to the IPP and NIU driver components of INCA inside the INCA API ( ) of the calls include application message identifiers and network data/mapping address data structures. These parameters allows the IPP and INCA NIU driver components to perform their functions such as multiplex and demultiplex messages to the intended applications or network addresses. For example, calls and parameters within calls are used to set up a connection using TCP and also implement client/server applications and functions such as “listen” etc.

inca ( )

The inca ( ) function call has to be used by any application that wishes to use INCA. This call sets up the required resources for the connection to continue. It also sets up a trusted memory mapping for the application to use the INCA Network interface from the user space. The call also initializes the protocol parameters and the protocol control blocks within the INCA IPP component and software library. The inca ( ) function call is a trusted and secure function call. Even though this is not a system call, it uses a set of existing OS system calls to setup the INCA network communicated data processing subsystem and the user-network buffer mapping. The inca ( ) call is a one time call and should always be followed by an inca_close ( ) call at the end of the application use of the INCA subsystem for networking.

The different functions that are performed within the inca ( ) call include: opening of the INCA Network device, creating an network data/mapping address for the application in the kernel network buffer, creating a mapping for the application to the kernel network data/mapping address, setting up a corresponding network data/mapping address in the user address space, and setting up a channel of communication over the mapped network data/mapping address. The function call also initializes the protocol data structures within the INCA library. The inca ( ) routine has to be called first by any application after initialization of the local and remote addresses. The return value has to be stored in a variable of type inca_t. The returned descriptor value of the function call inca ( ) has to be used in all further API calls. This descriptor also has to be used for closing the connection in the inca_close ( ) API function. The inca ( ) entry point into the INCA library differs from the socket system call in the Berkeley Socket API. For one, the inca ( ) call is a not a system call and hence involves less system overhead.

The INCA API call stores all the data structures in the user address space and avoids the most costly inter-address space copies. It initializes the INCA data structure Connector that is employed by the INCA library for storing all the state information and other details necessary for maintaining the connection. The syntax of the inca ( ) API call is fd=inca(local_addr, remote_addr, IPT_UDP, AF_INET). The third parameter passed to the inca ( ) function call is the transport protocol that has to be used. The values that the third parameter can take are any numeric to represent any protocols in the INCA library, e.g., IPT_UDP and IPT_TCP for UDP and TCP respectively. The protocol family to be used for the connection is specified in the fourth parameter to the inca ( ) function call, e.g.,. AF_INET for the Internet family of protocols. The library supports a direct data path for the applications without using the protocol suite in the INCA library. This is to facilitate the use of distributed computing with the INCA library. The INCA library is extensible and support for any desired protocol families can be added.

inca_close ( )

The inca_close ( ) function closes the INCA network data/mapping address structure and releases the memory that has been allocated when the network data/mapping address and the communication system was created by the inca ( ) call. The inca_close ( ) uses a series of system calls to free the virtual memory that is pinned for the communication segment. It is important that the applications use the inca_close ( ) call after each open with inca ( ). Otherwise, the valuable system resources that were pinned down by the communication segment will be unusable to the other applications running on the system. In the event of unforeseen termination of an application process on the host computer, the INCA NIU driver will free the device resources that are allocated by the inca ( ) API call.

inca_connect ( )

This entry point into the INCA library allows the client applications to communicate with a remote server. The connect ( ) function call has to be used with the same argument that is returned by the inca ( ) call. The inca_connect ( ) blocks until the server is contacted. If the server is unreachable or no reply was received from the server within a specified time, the call returns with a return value less than 1. This should be interpreted by the application as an error and the application should not continue using the read/write calls to the library. As an example of the use of this API call for connection oriented protocols, the TCP protocol suite in the INCA library is invoked by this API call. This sets up the initial state processing to initialize the TCP Finite State Machine (FSM). This essentially includes sending the TCP SYN segment to the remote node to which connection establishment was requested and wait for a ACK from the remote node to move the TCP FSM to the next established state. If an ACK is not received after 5 retries, the connection establishment fails and a “TCP pipe broken” message is returned.

inca_bind ( )

The inca_bind ( ) call is used by the API to bind the IP address and Port pairs. This can be used by the application for UDP datagram service over the INCA NIU driver provided interface. The inca_bind ( ) is similar to the bind ( ) call in the Sockets API. This has been provided to make the applications using the Socket API to be easily portable to the INCA Library. This function can be implemented within the inca ( ) API call itself. As an example of the use of this API call for non-connection oriented protocols, a UDP connection is set up for communication between the client and server. In the case of server, the server has to bind to ANY_PORT, which means it can accept connections from any host machine. The client on the other hand should “bind” to the server port. These ports are initialized in the call to inca ( ).

inca_listen( )

The inca_listen ( ) function call initiates a state transition to the LISTEN state in the TCP or other states of other protocol finite state machines. This call also initializes the queue size of the listen queue. The queue size determines the number of requests on the server that will be queued by the TCP or other protocol subsystem without rejecting a message or connection. If the queue size is specified as 5, any request that is received after the queue is filled with 5 outstanding requests is rejected. This will result in a “connection refused” message send to the client application that requested the connection. If the queue_size is negative or zero, a default value of 1 is assumed.

inca_accept( )

The inca_accept ( ) blocks for a client request and return if a client request for connection is received. inca_accept ( ) has to be called with the descriptor that was returned by the call to inca ( ). On returning from the inca_accept ( ) call, the application can either create a new thread to handle the request or continue processing the request in the main thread itself.

inca_send ( )

One implementation of the library provides a send and receive function call for transmission of data over a network. The read send call does not block. There could be separate send routine for UDP, TCP or different protocols. If only one send call is used, the INCA software library takes care of choosing the correct protocols, depending on the initialization effected by the inca ( ) call. The transmission is entirely taken care of by the INCA IPP protocol stack library. The data that is actually transmitted over the network may not have a one to one correspondence with the data written into the descriptor by the inca_send ( ) command. The INCA library contains a separate function to allocate memory that can allocate memory within the communication segment. This could be used in future additions to the INCA API and or NIU driver, where a network specific memory buffer feature can be implemented. In such an implementation, the inca_nsm structure will contain a header member, who should essentially contain all the protocol headers, and the message member will have memory to save the message that has to be transmitted. Using compiler constructs, the application can directly access the data instead of going through the cumbersome method of manipulating structures.

inca_recv ( )

The inca_recv ( ) retrieves any data that has been queued for reception for the descriptor after protocol processing. In the case of UDP, the entire datagram that has been received is retrieved. Since the UDP provides a datagram service, the packet size received should be comparable with the length argument in the inca_recv call. The INCA UDP does not perform buffering of the data received. The packets are queued in the same order as they were received based on the IP identification field.

inca_exit ( )

The function inca_exit ( ) is the recommended way to close the application. The application can use the exit ( ) function provided by existing OSs. The existing OS socket exit( ) call, in the case of TCP and many other connections, specifies a mean life time for the ports before the ports can be re-used after a connection is closed. The inca_exit ( ) API implements this on behalf of the application, exits from the application program and sets a timer for killing the TCP or protocol threads, making the ports immediately available to other users after a connection is closed. inca_close ( ) has to be called separately and is not included within the inca_exit ( ) function call. The method of closing the INCA—application interface is the invocation of the inca_close ( ) and inca_exit ( ) calls corresponding to each inca ( ) call when use of the INCA device is no longer needed or desired.

### OPERATIONAL EXAMPLE

To illustrate the workings and ease of use of the invention, the following description is provided. The INCA software library is loaded unto the computer's hard disk. If the INCA software is to be used for all network communications, the INCA software library is integrated or linked into the OS via a recompilation of the OS and the INCA software. If the INCA software is to be used on an application by application basis, then the INCA software is linked or integrated into the applications on a case by case basis. This could even be done at application run time. For the applications by application case, the application's API system calls are changed to the INCA API system calls. This procedure can be accomplished via a number of approaches. Once accomplished, all is complete and system operation can resume.

These two methods, INCA-OS recompilation or linking INCA to application programs and renaming of the application program API calls, provide a system by system approach to using the INCA networking software. System vendors or system administrators are the most likely candidates to use this method. Application program vendors or individual users as the most likely candidates to integrate or link the INCA library into application programs. Either way, the entire procedure can be accomplished in minutes to hours depending upon the implementor's familiarity with the applications, OS and NIU drivers. For existing applications that do not have their system calls modified, INCA allows the traditional network system interfaces (e.g., sockets) with the applications.

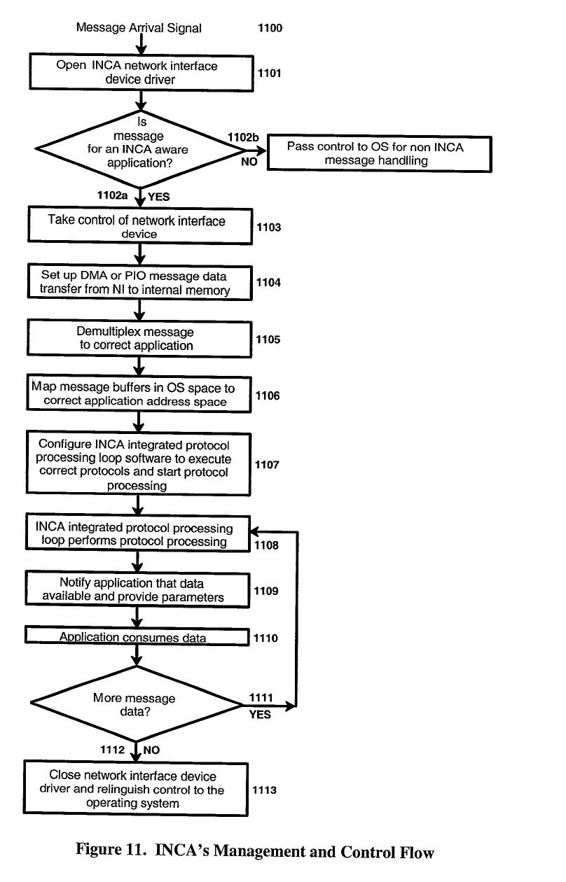

Referring to FIG. 11, the order of events for receiving network communicated data over the network is shown. Once system operation begins and network messages are received, the order of events for receiving data over the network are as follows: the NIU driver receives a message arrival notification from the NIU hardware 1100, typically via a hardware interrupt. The message arrival notification signal is received by the OS and initiates the opening of the INCA enhanced NIU driver—the INCA NIU driver 1101. The INCA NIU driver determines if the network message is for an application that can use the INCA software library to receive messages 1102. If the application is not “INCA aware,” control is handed over to the OS for further handling. If the application can use INCA to communicate, the INCA NIU driver takes control of the NIU 1103 (e.g., ATM network card) and sets up the registers, firmware, etc., of the device to transfer the network communicated data from the NIU to internal computer memory 1104. The INCA NIU driver uses an alternative INCA API call type programming code structure in place of the current OS system calls to take over the device and set up the data transfer from the NIU to computer memory. The INCA driver then uses the network data/mapping address data structure identifiers, derived from the standard protocol (i.e., ARP, RARP, ICMP, DNS, IP, TCP, UDP) addresses to demultiplex incoming messages to the recipient application program 1105. The network message buffers in OS address space are mapped to the recipient application's address space 1106. The INCA IPP software is configured and started for protocol processing 1107. The IPP software performs protocol processing to extract the data from the network message(s) 1108. Once the first IPP loop is completed, the application is notified via the INCA API calls that data is ready for consumption 1109. The application then processes the data 1110. If there are more messages to process, the IPP loop continues processing and the application continues consuming the data 1111. When all messages have been received 1112, the NIU driver closes the NIU and relinquishes control of the device to the OS 1113.

For transmission of data, the entire process occurs in reverse order and the application uses the API calls to communicate with the IPP software to determine which protocols and protocol options to use, sets up an network data/mapping address data structure by opening the INCA NIU driver with the open ( ) API call, establishes a network data/mapping address data structure, sets the network data/mapping address data structure and driver DMA characteristics with INCA API system calls such as ioctl ( ), and upon transmission completion, uses close ( ) to close the INCA NIU driver. The IPP component executes the selected protocols and places the resulting network communicated data into the send queue message buffers. The INCA NIU driver ceases control of the NIU and DMA resources with its “system calls” to the OS, maps the send queue in application address space to the OS message buffers in OS address space using the function mmap ( ), sets up and controls the DMA transfer from the OS message buffers to the NIU, and upon completion, relinquishes control of the NIU and DMA resources.

Envisioned Embodiments

The envisioned embodiments of the invention, INCA, include three general methods of incorporating INCA as described in the detailed description in any number of computing devices such as, but not limited to, PCs, workstation class machines and portable devices, e.g., personal digital assistants connected to wireless networks. The three general methods of utilizing INCA are: INCA in the OS, INCA in the application and INCA linked to either the OS or application.

INCA-OS Integration

INCA can be integrated into existing and future OSs. In this embodiment, the OS would perform network communications using the INCA software and functionality for all applications running on the host machine. INCA could be incorporated into OSs through a number of means such as recompilation of existing OS code with INCA code interwoven, or linked to the OS, or replacing the OS network communication functions software with software that implements the INCA architecture and performs the INCA functions as described. In this embodiment, the OS 220 manages the address mapping 280 between the virtual addresses of message buffers specified by an application and the physical addresses required for actual transmission and reception. This embodiment might be preferred for network appliances, network devices and small, portable network communication devices such as personal assistants where the integration of INCA and the OS would achieve the smallest memory footprint, lowest power consumption and fastest data throughput. This embodiment is illustrated in FIG. 18.

INCA-Application Integration

INCA can be integrated into existing and future application programs. In this embodiment, INCA can be added to individual applications on a one by one basis. The networking functionality, including protocol processing, could be integrated into applications via recompilation, linking or rewriting of the applications to implement the INCA architecture and functionality. In this embodiment, the OS 220 or the application program manage the address mapping 280 between the virtual addresses of message buffers specified by an application and the physical addresses required for actual transmission and reception. This embodiment might be preferred for application developers of such networking applications as a World Wide Web (WWW) browser. The application program could then utilize the performance advantage of INCA on any host, without requiring INCA to be already present on the host system. This embodiment is represented in FIG. 2.

INCA Library Linked to OS/Application

A third general embodiment is a separate INCA software library stored on the host computer system, where the OS and or the individual application programs link to the INCA library to perform network data communication using the INCA architecture and functionality. The linking of the OS or application to INCA could be performed a number of ways such as at run time or some time prior to actual use of INCA for network data communication. In this case, INCA software is not actually residing inside the OS or application code, but rather the INCA software is a separate set of software residing somewhere in the host machine or on a network on a remote host within reach of either OS or application. In this embodiment, the OS 220 or the application program manage the address mapping 280 between the virtual addresses of message buffers specified by an application and the physical addresses required for actual transmission and reception. These two embodiments would resemble FIG. 18 and FIG. 2, only the INCA software would not be interwoven with the actual OS or application software.

Results

Tests were conducted on commercially available systems, configured with COTS software, NIUs and a FastEthernet network. The INCA testbed consisted of two machines connected via a 100 Mbps FastEthernet. INCA allows applications to process data at rates greater than 10 Mbps, thereby a normal 10 Mbps Ethernet would have caused the network to limit INCA performance. A SUN Microsystems UltraSPARC1 WS with a 143 MHz ULtraSPARC1 CPU, 64 Megabytes (MB) of RAM, running Solaris 2.5.1 (also known as SUN OS 5.5.1), with a SUN SBus FastEthernet Adapter 2.0 NIU was connected via a private (no other machines on the network) 100 Mbps FastEthernet to a Gateway 2000 PC with a 167 MHz Pentium Pro CPU, 32 MB of RAM, running the Linux 2.0 OS with a 3Com FastEtherlink (Parallel Tasking PCI 10/100 Base-T) FastEthernet NIU. Messages of varying lengths from 10 bytes to the maximum allowable UDP size of 65K bytes were sent back and forth across the network between the machines using an Internet WWW browser as the application program on both machines. This architecture uses the actual application programs, machines, OSs, NIUs, message types and networks found in many computing environments. The results should therefore have wide applicability.

SUN UltraSPARC1 Workstation with and without INCA

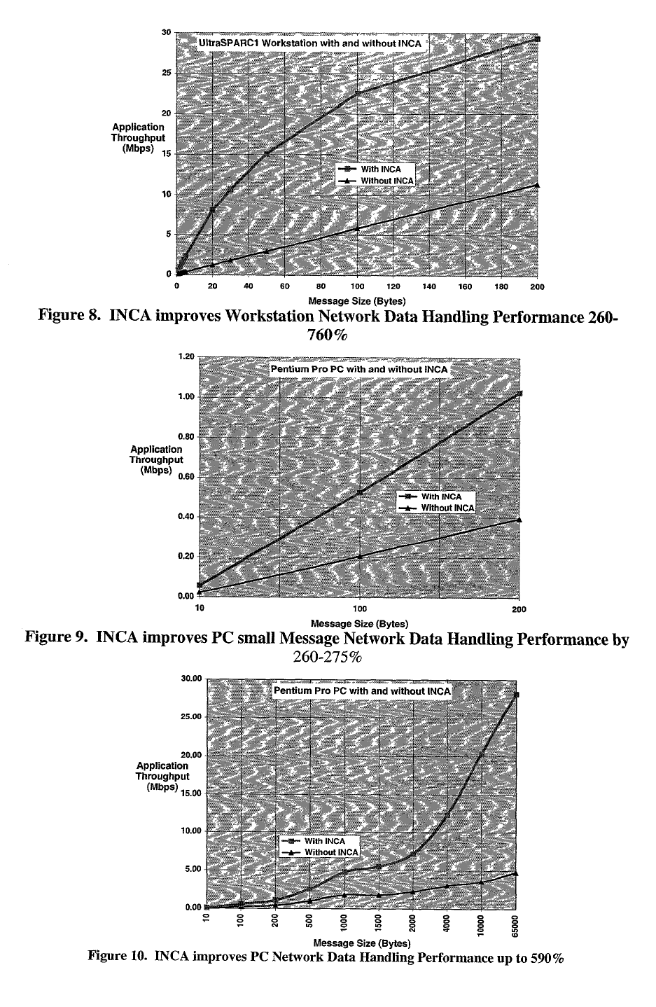

Referring to FIG. 8, the graph illustrates the fact that on a high performance WS class computer, INCA outperforms the current system at application program network message throughput by 260% to 760% depending upon the message size. Since 99% of TCP and 89% of UDP messages are below 200 bytes in size, the region of particular interest is between 20 and 200 byte size messages.

Gateway 2000 Pentium Pro PC with and without INCA

Referring to FIGS. 9 and 10, the graphs illustrate that on a PC class computer, INCA outperforms the current system at application program network message throughput by 260% to 590%. FIG. 9 shows INCA's 260% to 275% performance improvement for message sizes of 10 to 200 bytes. FIG. 10 shows that as message sizes get larger and larger, up to the existing protocol limit of 65K bytes, INCA's performance improvement becomes larger and larger reaching the maximum of 590% at a message size of 65K bytes.

Although the method of the present invention has been described in detail for purpose of illustration, it is understood that such detail is solely for that purpose, and variations can be made therein by those skilled in the art without departing from the spirit and scope of the invention. The method of the present invention is defined by the following claims.

I claim:

1. A method for improving the internal computer throughput rate of network communicated data comprising:
transferring network communicated data from a standard network interface device to an application address space with only one physical copying of the data;
executing communication protocols in an integrated protocol processing loop by having the integrated protocol processing loop perform all protocol data manipulation functions on the data in a single loop on computer word size segments of the data;
calculating communication protocol checksums one computer word size of data at a time within the integrated protocol processing loop; and
address mapping of the data occurs in response to call functions, where the operating system's calls are bypassed.
